(19) United States
(12) Patent Application Publication
(10) Pub. No.: US 2013/0080213 A1
(43) Pub. Date: Mar. 28, 2013

(54) Fungicidal Mixtures And Their Use

(71) Applicant: Jeff Peters, Greensboro, NC (US)

(72) Inventor: Jeff Peters, Greensboro, NC (US)

(73) Assignee: SYNGENTA CROP PROTECTION LLC, Greensboro, NC (US)

(21) Appl. No.: 13/501,484

(22) PCT Filed: Oct. 12, 2010
(86) PCT No.: PCT/US2010/052335

§ 371 Date: Dec. 5, 2012

Related U.S. Application Data
(60) Provisional application No. 61/250,588, filed on Oct. 12, 2009.

(51) Int. Cl. G06Q 99/00

(52) U.S. Cl. 705/7.38

(57) ABSTRACT

A computer device is provided for implementing a system configured to provide greenhouse gas footprint information used in evaluating an environmental impact of one of a commercial and municipal facility. The computer device receives a query from a user, the query being associated with a plurality of facility parameters associated with the facility. The computer device determines from the facility parameters at least one of a greenhouse gas emission estimate indicative of an amount of emitted greenhouse gas associated with the facility and a greenhouse gas reduction estimate indicative of an amount of greenhouse gas sequestered by the facility. The computer device further provides an indicia of at least one of the greenhouse gas emission estimate and the greenhouse gas reduction estimate via a display device in direct response to the query. Associated systems and methods are also provided.

### BACKGROUND

1. Field of the Invention

The present invention relates to the field of greenhouse gas emissions and, more specifically, to systems, devices, and methods for providing greenhouse gas footprint information used in evaluating an environmental impact of a facility as determined by various parameters associated with the facility.

2. Description of Related Art

In recent years, global warming has received a substantial increase in coverage by media outlets. As such, corporations and consumers, as well as human beings in general, have become more concerned with their impact on the environment. Such concern has lead to proposed legislation and environmental movements across the world in an effort to improve consumer awareness and choice-consciousness when choosing products and companies with which to associate. To that end, many decisions, which range in a wide variety, are now driven by environmental factors associated with a particular choice of service, product, etc., whereby generation of carbon dioxide (CO₂) or other greenhouse gas emissions can be reduced.

In this regard, providing ways to reduce generation of greenhouse gas emissions has become an interesting topic of discussion. However, another approach for reducing our environmental impact is to increase greenhouse gas or carbon sequestration. Carbon sequestration is a geoengineering technique for the long-term storage of carbon dioxide or other forms of carbon, for the mitigation of global warming. For example, modification of agricultural practices is a recognized method of carbon sequestration, as soil can act as an effective carbon sink. Carbon emission reduction methods in agriculture can be generally grouped into two categories: (1) reducing and/or displacing emissions and (2) enhancing carbon removal. Some of these reductions involve generally increasing the efficiency of facility operations (i.e. more fuel-efficient equipment) while some involve interruptions in the natural carbon cycle. While a wide variety of carbon control techniques are possible within agriculture, not all have the same degree of effectiveness, and the degree of effectiveness can also vary considerably when the normal variations in turf management such as location, climate, weather, plant varieties, etc. are considered. Also, some effective carbon sequestering techniques can negatively impact other areas of environmental concern.

With such a wide variety of parameters accounting for greenhouse gas emissions, as well as greenhouse gas sequestration, associated with a particular facility, determining estimates of such emissions and sequestration is problematic. Such information would be useful to land owners, consumers, corporations, etc. for determining, evaluating and managing its individual contribution to greenhouse gas emissions and sequestration efforts. Furthermore, the ability to alter parameters associated with the facility and to determine optimum values thereof would be advantageous for those seeking to maximize efforts to address global warming and to reduce the overall environmental impact of a facility.

Therefore, it would be advantageous to provide methods, systems and computer program products capable of estimating greenhouse gas emissions and greenhouse gas sequestration associated with a facility based on various parameters associated therewith, such as, for example, energy consumption, water consumption, facility profile, and maintenance activities, so as to provide a user with greenhouse gas footprint information associated with the facility for making evaluations and/or management decisions thereof.

### BRIEF SUMMARY OF THE INVENTION

The needs outlined above are met by the present invention which, in various embodiments, provides a greenhouse gas evaluation method, system, and/or device that overcomes many of the technical problems discussed above, as well other technical problems, with regard to the providing of greenhouse gas footprint information used in evaluating and managing the environmental impact of a facility such as a commercial or municipal facility.

The above and other needs are met by the present invention which, in one embodiment, provides a method for providing greenhouse gas footprint information associated with one of a commercial and municipal facility. Such a method comprises receiving a query from a user over the computer network, the query being associated with a plurality of facility parameters associated with one of a commercial and municipal facility. The method further comprises determining, via a processor portion, from the facility parameters at least one of a greenhouse gas emission estimate indicative of an amount of emitted greenhouse gas associated with the commercial or municipal facility and a greenhouse gas reduction estimate indicative of an amount of greenhouse gas sequestered by the commercial or municipal facility. Further, the method comprises providing an indicia of at least one of the greenhouse gas emission estimate and the greenhouse gas reduction estimate via a display device or other reporting instrument in direct response to the query, so as to provide greenhouse gas footprint information capable of use: (1) in evaluating an environmental impact of the commercial or municipal facility; and/or (2) in managing facility parameters to mitigate such impact. In some embodiments, the method may further comprise determining a net greenhouse gas footprint estimate from the difference between the greenhouse gas emission estimate and the greenhouse gas reduction estimate.

Another advantageous aspect of the present invention comprises a system for implementing the associated method for providing greenhouse gas footprint information used in evaluating the environmental impact of a commercial or municipal facility or in managing facility parameters, as described herein. Such a system may be implemented in computer hardware, software, or a combination of computer software and hardware, having one or more executable and/or processing portions for accomplishing an associated method according to other embodiments of the present invention. In a representative embodiment, a greenhouse gas evaluation system is at least partially initiated and established on an intermediary computer or computer device, capable of implementing the described associated method, that is part of a larger computer network such as, for example, the Internet. Such an intermediary computer or computer device may comprise, for example, a desktop personal computer, a laptop personal computer, a hand held computer or PDA, a smart phone, a server, a router, a mainframe computer or like devices or combinations thereof capable of implementing the described functions as known to one skilled in the art. Once established on the intermediary computer or computer device, the greenhouse gas evaluation system is accessible to a customer (also referred to herein as “user” or “consumer”) via a user's computer device (which also may comprise a part of the greenhouse gas evaluation system) that is discrete with respect to the intermediary computer or computer device, but capable of communicating with the computer network and, as a result, with the intermediary computer or computer device through, for example, network communication lines (such as a wired network, a wireless network, a cellular network or the like). According to other embodiments, the computer device may be capable of implementing the associated method in a stand alone manner and not forming part of a larger network, in which the one or more executable and/or processing portions are capable of execution/processing on the computer device without the aid of a larger network.

Thus the methods, systems, and devices for providing greenhouse gas footprint information used in evaluating the environmental impact of a commercial or municipal facility, as described in the embodiments of the present invention, provide many advantages that may include, but are not limited to: providing a greenhouse gas evaluation system that provides a user with greenhouse gas emission and sequestration information associated with the facility, and providing a comparison of the determined greenhouse gas emission and sequestration information with familiar comparative sources. In one particular embodiment, the present invention may be particularly suited for evaluating the environmental impact of a facility having intensely managed green spaces or turf areas, such as, for example, golf courses, athletic playing fields and municipal parks. The present invention also is suited for evaluating the environmental impact of the turf areas or green spaces managed, for example, by a lawn care service business; or the environmental impact of multiple facilities being managed together under a common brand or franchise. In this way, a comparison of the determined greenhouse gas emission and sequestration information can be provided across such commonly managed facilities.

These advantages and others that will be evident to those skilled in the art are provided in the methods, systems, and devices of the present invention. Importantly, all of these advantages allow a user to more effectively and efficiently make greenhouse gas footprint evaluations and assessments.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic representation of a system for providing a user with greenhouse gas footprint information for a golf facility based on various parameters associated with the golf facility, according to one embodiment of the present invention;

FIG. 2 is a schematic representation of a computer device for providing a user with greenhouse gas footprint information for a golf facility based on various parameters associated with the golf facility, according to one embodiment of the present invention;

FIG. 3 is a flow chart of a method according to one embodiment of the present invention including the steps of receiving a query associated with a plurality of facility parameters associated with one of a commercial and municipal facility, determining at least one of a greenhouse gas emission estimate associated with the facility and a greenhouse gas reduction estimate associated with the facility, and providing an indicia of at least one of the greenhouse gas emission estimate and the greenhouse gas reduction estimate in direct response to the query;

FIGS. 4-12 illustrate interface displays according to one embodiment of the present invention wherein a user may input various parameters associated with a golf facility for inclusion in a query submitted so as to receive, in return, greenhouse gas footprint information used to evaluate the environmental impact of the golf facility; and

FIG. 13 illustrates a display according to one embodiment of the present invention wherein a user may view indicia of greenhouse gas footprint information associated with a golf facility according to various parameters associated with the golf facility.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. The methods, systems, and devices of the present invention are described in a greenhouse gas footprint evaluation environment, wherein a user provides information related to a municipal facility or a commercial facility, such as, for example, a golf course facility, such that the benefits of the methods, systems, and devices may extend to reduced greenhouse gas emissions, as well as increased greenhouse gas sequestration. As used herein, the term “facility” may relate to a broad number of facility types such as, for example, a commercial facility (e.g., a golf course facility, an industrial facility), a municipal facility (e.g., parks, urban or suburban communities), or any other facility or collection of facilities that may be able to use agricultural type protocols to reduce generation of greenhouse gas emissions or otherwise improve sequestration thereof. Embodiments of the present invention as described herein may provide aspects particularly advantageous to facilities (commercial, municipal, etc.) having intensely managed turf areas or which, in addition to non-turf components, otherwise includes a turf component or a green space which may include trees or other managed flora.

In general, a user inputs various parameters associated with a commercial or municipal facility such that the inputs may be compiled into a query, wherein the inputted parameters of the query are used to estimate greenhouse gas emissions and/or sequestration associated with the facility. In addition, the user may receive, in direct response to the query, information related to the greenhouse gas emissions and/or sequestration associated with the facility. In this manner, the user may input actual parameters currently associated with the facility or artificial (hypothetical) parameters associated with the facility, or combinations of the actual and artificial parameters. By including artificial parameters, the user may be able to determine parameter adjustments that provide significant or substantial changes to the facility's environmental impact by way of a simulation or decision support tool. As such, the user benefits by increasing the available information for making evaluations and assessments of implementing various products, procedures, etc. for operating the facility, while limiting costs by eliminating actual testing of such products, procedures, etc. prior to implementation. In one embodiment, real time, current or historical data regarding one or more facility operations or regional variations may be received over a network or by telemetry from sensors and automatically entered into the query module. In this way, the user benefits by increasing the information available for determining dynamic trends of the environmental impact that may result from implementing various product inputs, procedures and/or management decisions pertaining to a facility. The methods, systems, and devices of the present invention can be used by any number of interested parties. For example, the present invention may be used by groundskeepers, golf course superintendents, municipal greenspace or landscape managers, sellers of turf management measures (i.e., sellers of fertilizers, seeds, and the like), lawn care operators, sellers of lawn care services, and students.

In this regard, the methods, systems, and computer program products disclosed herein are generally directed toward determining and providing greenhouse gas footprint information for aiding in evaluations of a greenhouse gas footprint associated with a commercial or municipal facility. Such determinations may be accomplished by, for example, a computer device executing an appropriate computer program product. For purposes of this discussion, it is recognized and understood that the term ‘computer device’ includes, but is not limited to, desktop and laptop computers, as well as cellular phones, smart phones, personal digital assistants (PDA), and other electronic devices, both portable and non-portable, having processing capabilities.

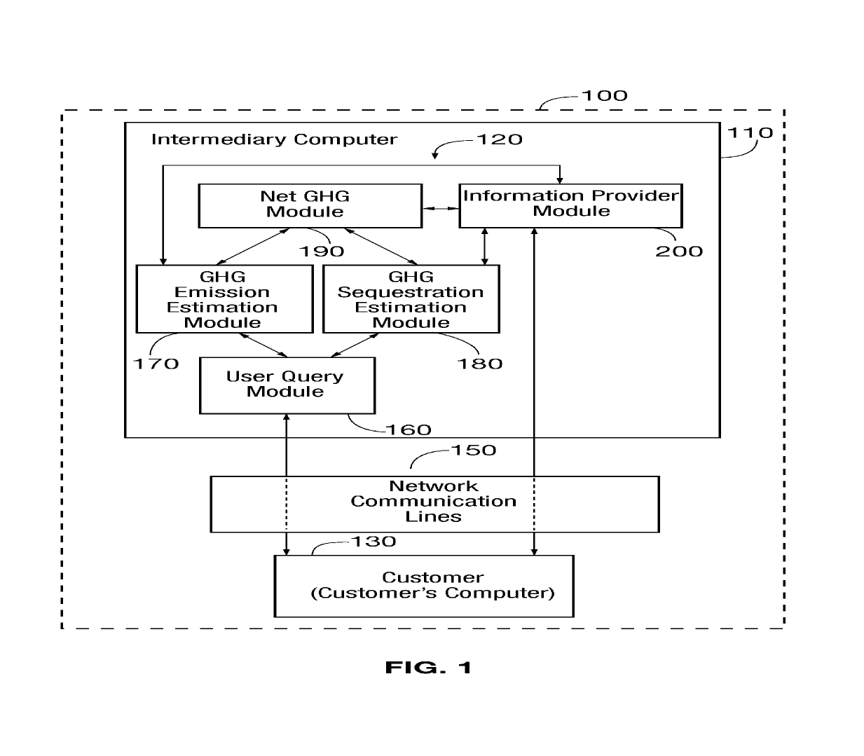

FIG. 1 is a schematic representation of a system, operating over a computer network, for receiving a query from a user, and for providing greenhouse gas footprint information to the user for use in evaluating the greenhouse gas footprint associated with a commercial facility such as, for example, a golf facility (e.g., golf course, driving range, etc.), according to one embodiment of the present invention, and is representative of a system capable of implementing a method for providing greenhouse gas footprint information used in evaluating parameters associated with a commercial facility and an environmental impact thereof in accordance with further embodiments of the present invention. The system 120 may be initiated, developed, and administered on an intermediary computer or other computer device 110, wherein the intermediary computer or other computer device 110 is part of a larger computer network 100 such as, for example, the Internet. Such an intermediary computer or computer device 110, referred to herein as “intermediary computer 110” for convenience and brevity, may comprise, for example, a desktop personal computer, a laptop personal computer, a smart phone, a server, a router, a mainframe computer or like devices or combinations thereof capable of implementing the functions and methods described herein as will be appreciated by one skilled in the art.

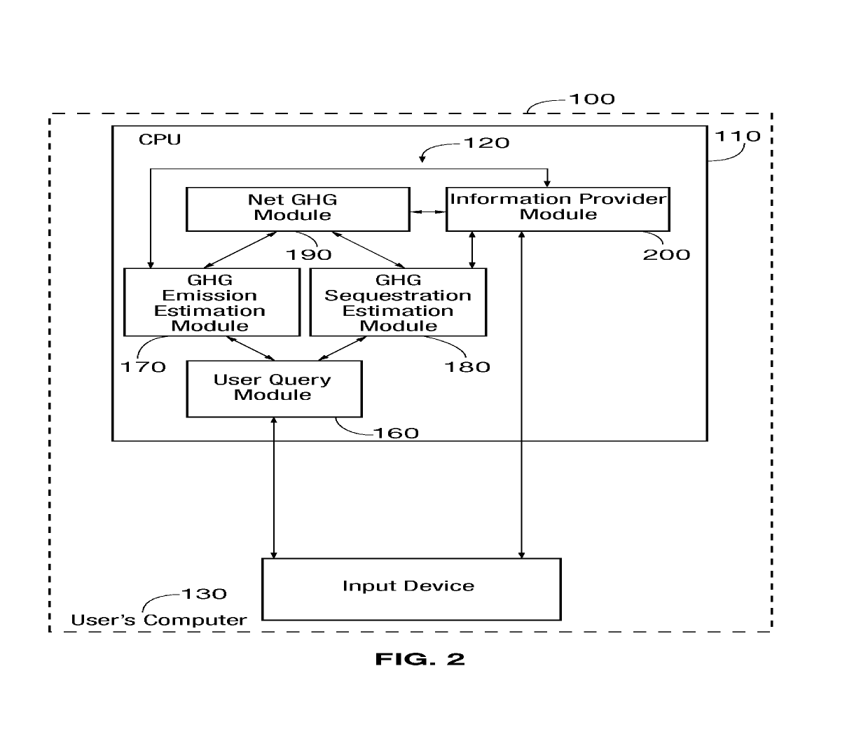

Once established on the intermediary computer 110, the system 120 is accessible to a user through a user's computer 130, referred to herein as “user 130” for convenience and brevity, capable of communicating with the computer network 100 and communicable with the intermediary computer 110 through, for example, network communication lines 150. Note that, while a simple schematic of a single computer device in communication with a computer network is presented herein, it is understood that this concept is representative of communication through an Internet site on, for example, the World Wide Web, and may involve many different computers and associated equipment, wherein the concept of communication via the Internet is known to one skilled in the art. Note that the intermediary computer 110 is typically remote from, discrete, and independent of the user 130. However, in some instances, embodiments of the system and corresponding method described herein as being performed by the intermediary computer 110 may be hosted by a user's computer 130 (as shown in FIG. 2), in which case the user's computer 130 may also serve as the intermediary computer 110 consistent with the spirit and scope of the present invention.

In order to explore the resources offered by the system 120 such as, for example, to determine greenhouse gas footprint information based on various parameters associated with a facility, the user 130 accesses the intermediary computer 110 over the network communication lines 150. Generally associated with the system 120 on the intermediary computer 110 are a user query module 160, a GHG emission estimation module 170, a GHG sequestration estimation module 180, and an information provider module 200. According to some embodiments, a net GHG module 190 may also be associated with the system 120. The greenhouse gas footprint evaluation system 120 is generally implemented in computer software, though the system 120 may also, in some instances, be implemented in a combination of software and hardware. The information gathered through the user query module 160, the GHG emission estimation module 170, the GHG sequestration estimation module 180, and/or the net GHG module 190 is generally stored in, for example, one or more databases in a memory device (not shown) incorporated within or otherwise associated with the intermediary computer 110. Accordingly, the system 120 may provide data mining opportunities as will be realized by one skilled in the art. Further, the user query module 160, the GHG emission estimation module 170, the GHG sequestration estimation module 180, the net GHG module 190, and the information provider module 200 are typically implemented in computer software, though these components may be implemented by a combination of software and hardware, in some instances. For example, the GHG emission estimation module 170 and/or the GHG sequestration estimation module 180 may include or be disposed in communication with a router, server, switch, or the like, for appropriately allowing access thereto for retrieving, for example, geographic information systems (GIS) data, fuel rates/costs, energy consumption rates/costs associated with a facility. In addition, the information provider module 200 may comprise, for instance, a display, a driver, or other mechanism for presenting text, graphics, audio, paper reports, e-mails, instant messages, or the like to display greenhouse gas footprint information, such as, for example, greenhouse gas emission and sequestration estimates for the facility, and/or other information associated therewith through the system 120.

Generally, these elements or modules cooperate to form the system 120, implemented in computer software or a combination of software and hardware, including one or more processing portions capable of executing embodiments of a method for providing greenhouse gas footprint information associated with a commercial or municipal facility according to the present invention. Thus, embodiments of such methods according to the present invention may be implemented by one or more corresponding processing portions of an associated system or computer device, wherein each processing portion may comprise a software component, or both a software and hardware component, capable of implementing one or more of the specified functions. An associated computer software program product may also be provided, wherein such a computer software program product may include one or more executable portions capable of being executed by an appropriate computer device to perform any or all of the methods described herein. Accordingly, the operation of the greenhouse gas footprint evaluation system 120 and its associated elements may be more particularly illustrated from the description of an associated method corresponding to one embodiment of the present invention.

In addition to providing methods, systems, and devices, the present invention also provides computer program products for performing the operations described above. The computer program products have a computer readable storage medium having computer readable program code means embodied in the medium. The computer readable storage medium may be part of a storage device and may implement the computer readable program code means to perform the above discussed operations.

In this regard, FIGS. 1 and 2 are block diagram illustrations of methods, systems, and devices according to the invention. It will be understood that each block or step of the block diagram and combinations of blocks in the block diagram can be implemented by computer program instructions. These computer program instructions may be loaded onto a computer device or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer device or other programmable apparatus to function in a particular manner, such that the instructions stored in the computer-readable memory produce an article of manufacture including instructions which implement the function specified in the block diagram, flowchart or control flow block(s) or step(s). The computer program instructions may also be loaded onto a computer device or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

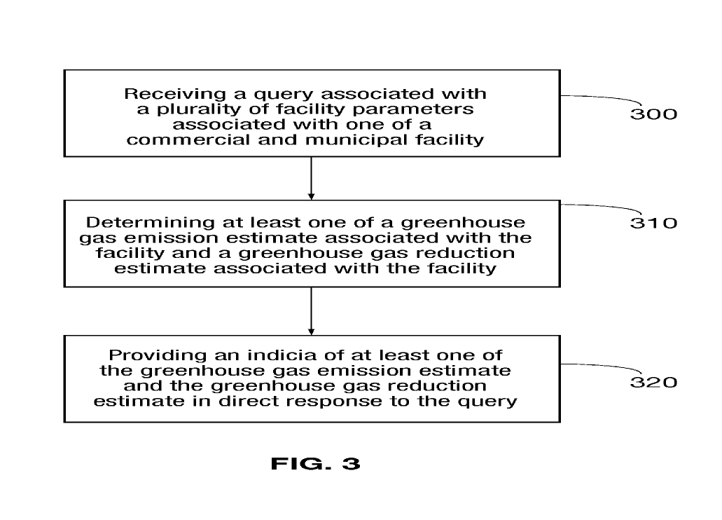

FIG. 3 illustrates a flow chart depicting a method according to one embodiment of the present invention for providing greenhouse gas footprint information associated with a commercial or municipal facility. The method may comprise, for example, step 300 for receiving a query from a user, the query being associated with a plurality of facility parameters associated with one of a commercial and municipal facility; step 310 for determining from the facility parameters at least one of a greenhouse gas emission estimate indicative of an amount of released greenhouse gas associated with the facility and a greenhouse gas reduction estimate indicative of an amount of greenhouse gas sequestered by the facility; and step 320 for providing an indicia of at least one of the greenhouse gas emission estimate and the greenhouse gas reduction estimate in direct response to the query. Thus, the method embodiments of the present invention may further report or display greenhouse gas footprint information to a user for evaluating the environmental impact of the facility.

### Receiving Step

The receiving step 300 may comprise in one embodiment, for example, monitoring or detecting input from a user regarding parameters and/or information related to the facility, wherein such inputs are compiled into a query submitted by the user. All or part of the parameters, information or query may be manually or automatically entered. That is, the input values/parameters associated with the facility are used to determine the greenhouse gas emissions and sequestration estimates provided by the various aspects of the present invention. In this regard, there is no limit on the number of input values/parameters that may be used to compile the query submitted for determining and providing the greenhouse gas footprint information regarding a facility. By way of example, the methods, systems, and computer program products disclosed herein may be used to determine greenhouse gas footprint information based on various parameters such as, for example, facility profile, facility energy consumption, facility maintenance programs/activities, and any other parameter of interest to the user or known by those of skill in the art. In one particular embodiment, the commercial facility under evaluation may be a golf course facility. In such an embodiment, the parameters associated with the golf course facility may include, for example, a landscape profile, maintenance activities (mowing, irrigation water usage, fertilizer, and pesticide usage), management of tree stand (for example, by injection of trees with emamectin benzoate sold under the trademark TREE-Age®, manufactured by Syngenta Crop Protection), golf cart usage, clubhouse energy usage, and plant growth regulator (PGR) usage (for example, the PGR product may be a product such as trinexapac-ethyl sold under the trademark PRIMO MAXX®, available through Syngenta Crop Protection, Incorporated).

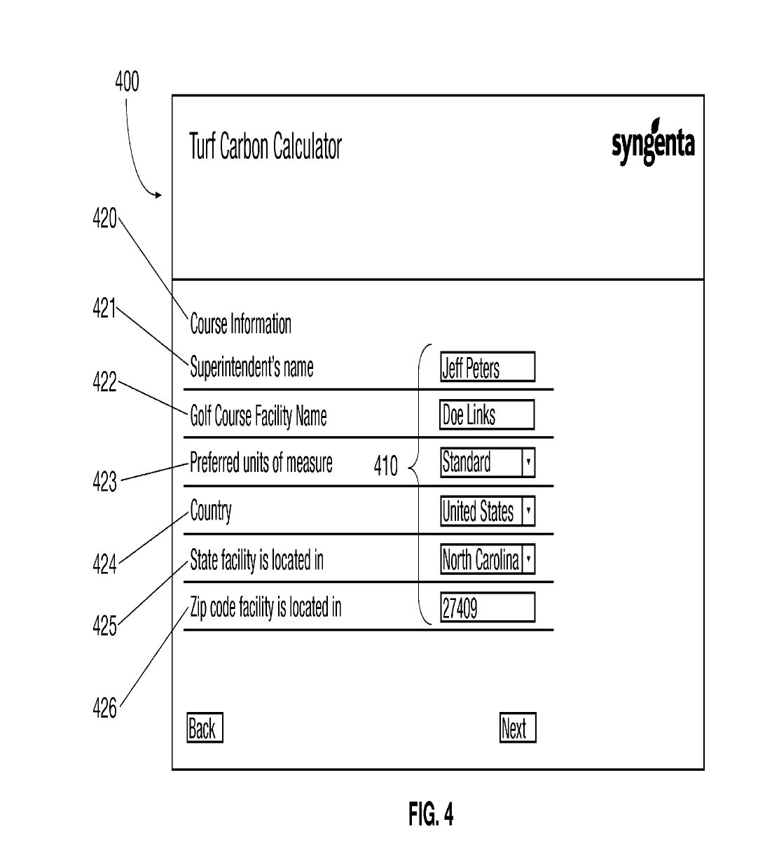

According to some embodiments, the receiving step 300 may be performed by a computer device in communication via wired and/or wireless networks (such as the Internet) with a computer device operated by the user, by receiving satellite and aerial facility imagery, by receiving on-the-go sensor technology information with parameters associated, for example, with one or more maintenance activities, etc. In other instances, the user may access an internet website hosted by a computer device operated by a third-party, wherein the user may “click-through” there through to access the internet website. In this manner, the input parameters associated with the commercial facility may be received by the third party via the internet website and the greenhouse gas footprint information provided via the internet website operated by the third-party. For example, FIGS. 4-12 illustrate an internet website displayed on a display device such that the user is capable of inputting the input parameters or values as determined by the user. Thus, according to some embodiments of the present invention, the user may access the greenhouse gas footprint tool via an Internet website configured to present a display 400 shown generally in FIGS. 4-12 such that the user may input facility related information into any one of a plurality of facility input entry fields, as generally and collectively designated 410, shown in the display 400.

According to some method, system, and device embodiments of the present invention, the display 400 shown generally in FIGS. 4-12 may display the facility input entry fields 410 as interactive graphics that may be selected (i.e., by the click of a mouse), causing the display 400 to permit entry of numerical values into the facility input entry fields 410 with, for example, a keyboard device, as understood by those of skill in the art. In other instances, the user may interact with drop down menus that provide the user with multiple fixed options from which to choose, as understood by those of skill in the art. While the displays and facility input entry fields illustrated by FIGS. 4-12 are particularly directed to a golf course facility and parameters related thereto, such embodiments are not meant to limit the present disclosure and are only provided as an exemplary embodiment thereof. As previously noted, embodiments of the present disclosure may be implemented in regard to various individual or multiple commercial or municipal facilities and parameters associated therewith. For example, the profile of a lawn care services business may include a number of residences under management and relevant information, whereas the profile of a resort may include a number of individual golf courses under management and relevant information with respect thereto.

In accordance with embodiments of the present invention, the input parameters associated with the commercial or municipal facility may be determined from actual data provided or otherwise collected by the user. In some instances, the data may be determined over a predetermined duration of time, such as, for example, a year; or over a shorter period of time, such as a month or a quarter, to allow dynamic facility management during a particular year. Of course, the input parameters may, in some instances, include purely hypothetical data provided by a user. That is, the greenhouse gas information provided by embodiments of the present invention, in some instances, may not be based upon any specific data or otherwise any actual sampling data. Instead, the hypothetical parameter data may used, for example, to imagine, plan or provide decision support to various scenarios under which a particular course of action or strategy may be more effective to decrease the greenhouse gas emissions of the facility and/or increase the greenhouse gas sequestration by the facility.

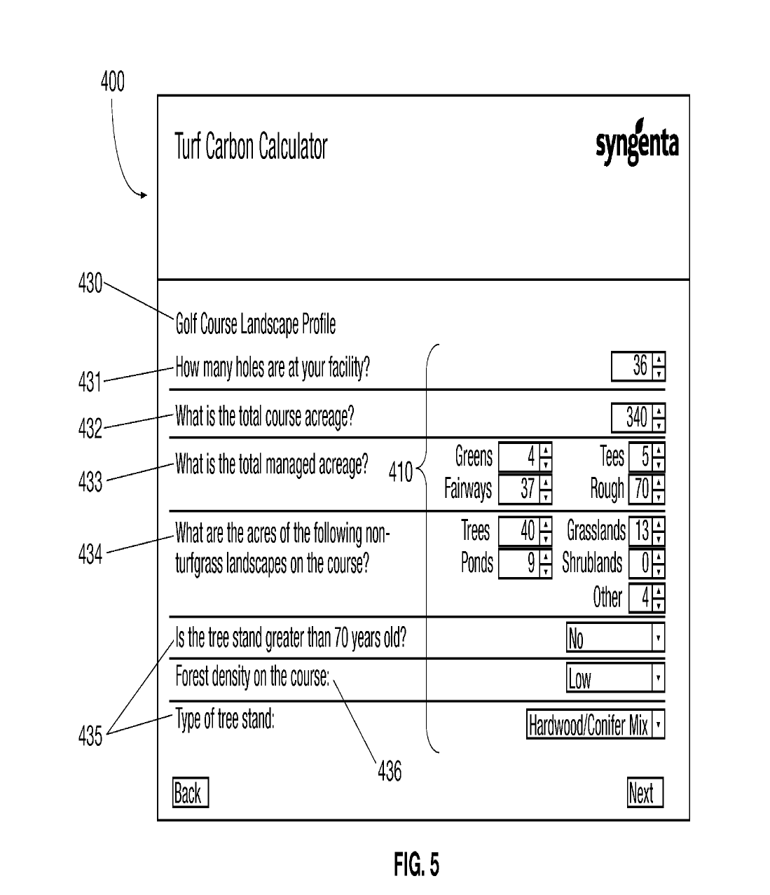

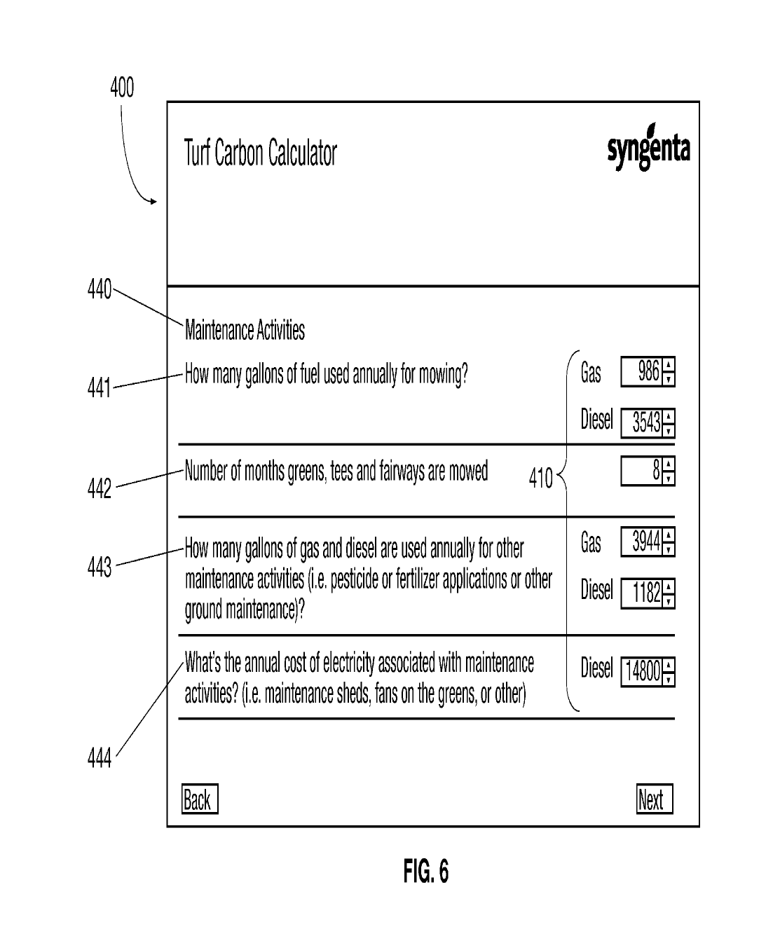

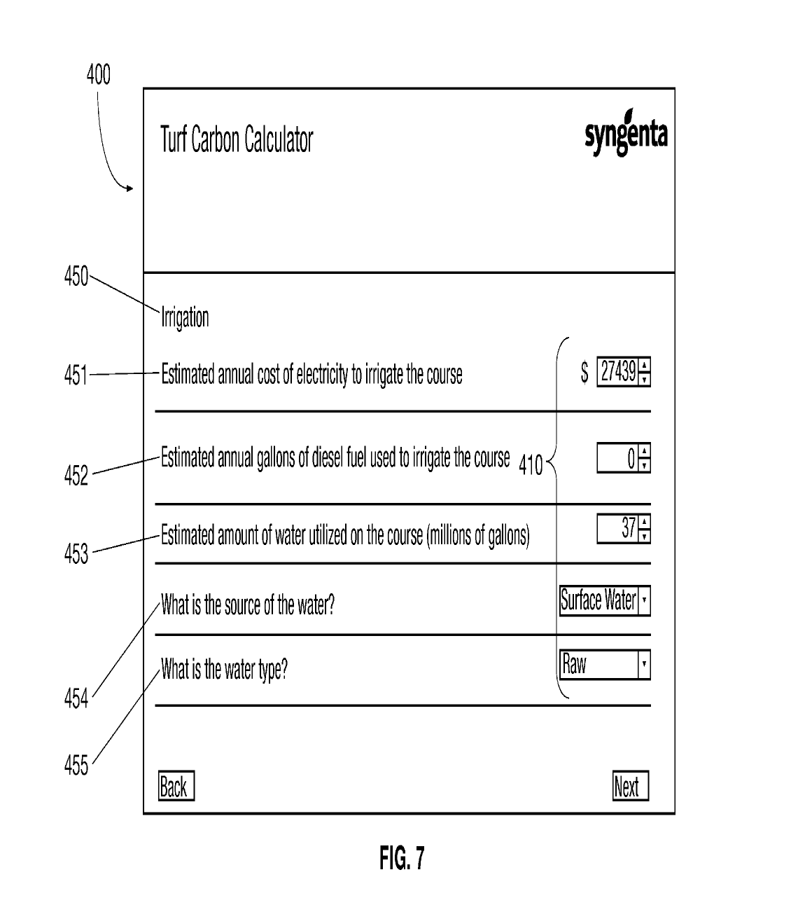

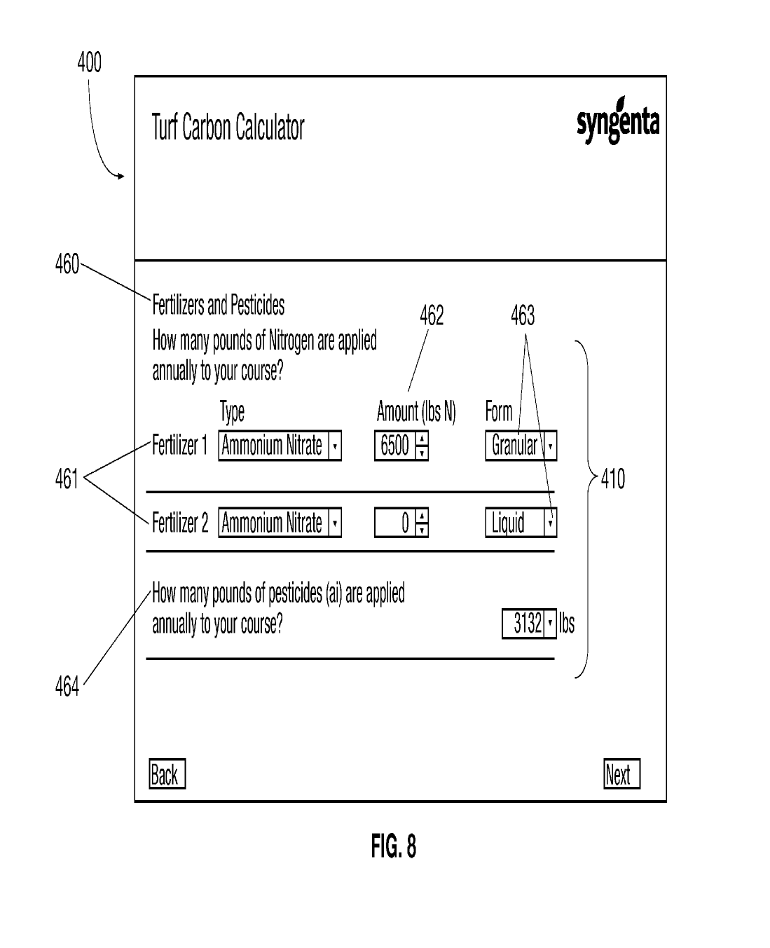

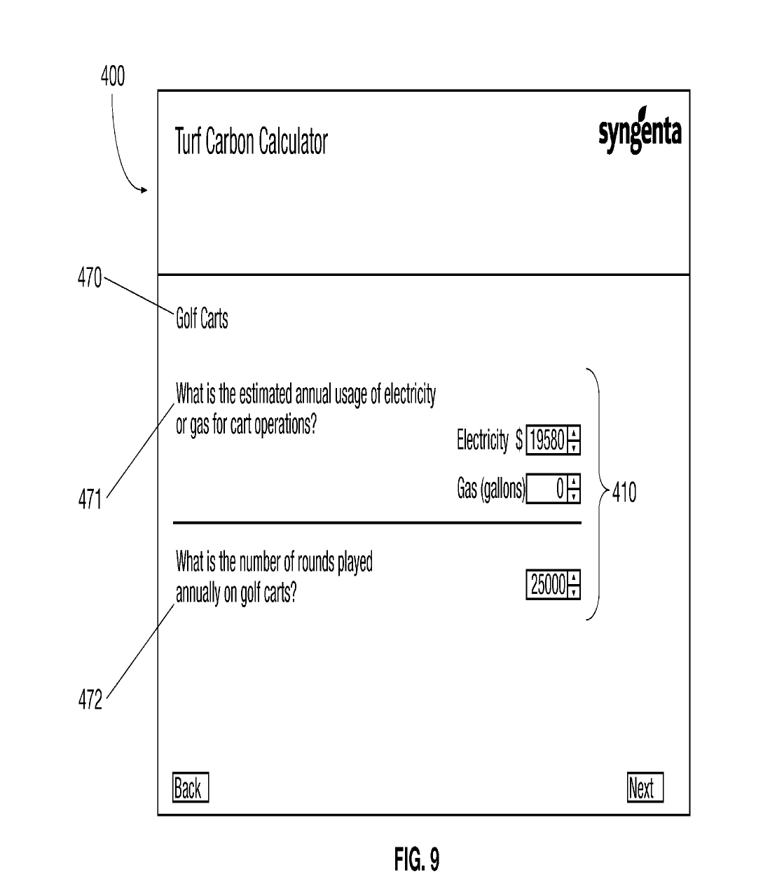

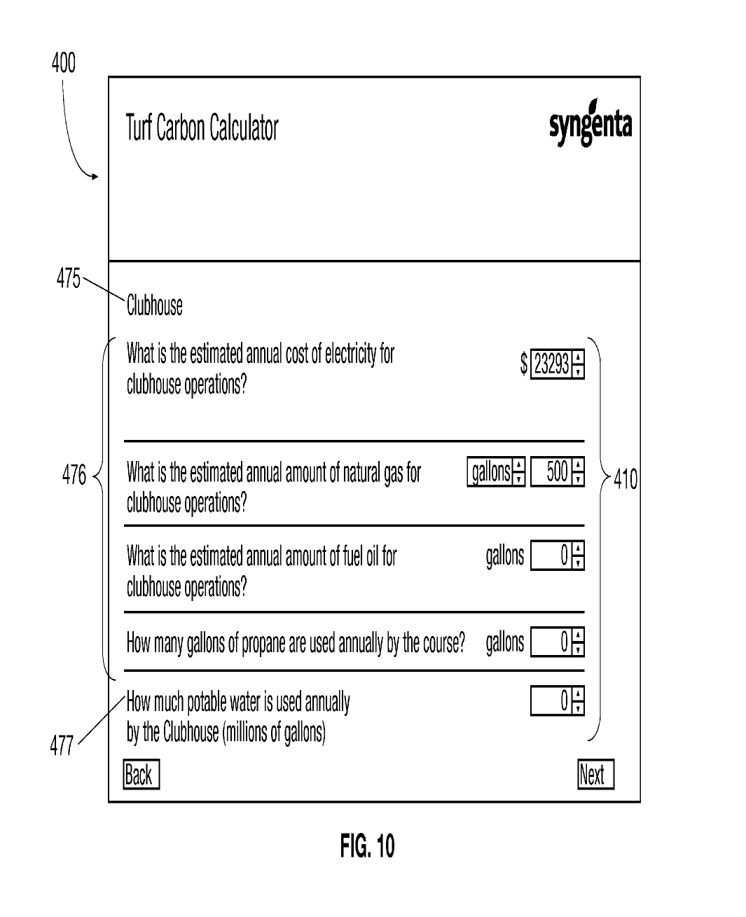

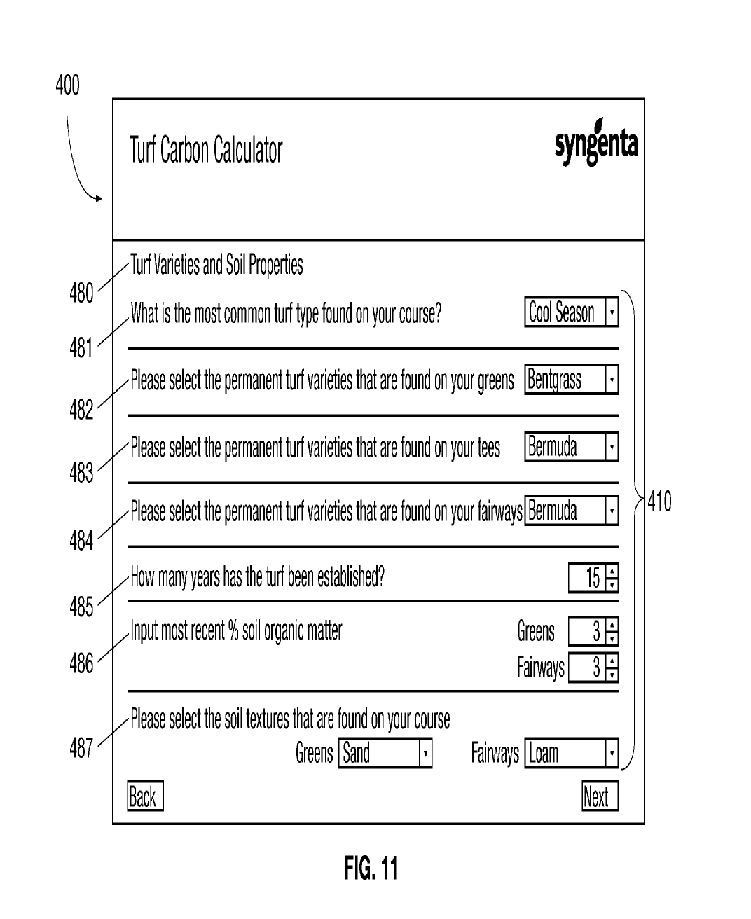

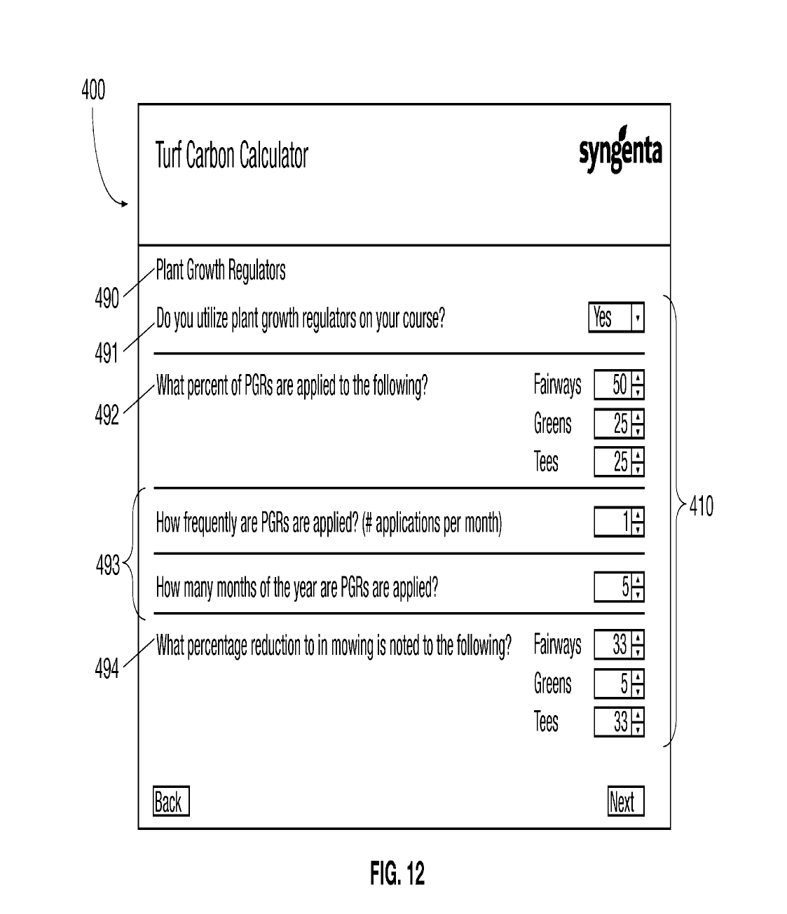

The input parameters associated with the facility may include any information used to develop/determine/calculate a greenhouse gas emission estimate indicative of an amount of greenhouse gas emitted by the facility and/or a greenhouse gas reduction estimate indicative of an amount of greenhouse gas sequestered by the facility. Such types of parameters may include sources of GHG (e.g., energy consumption) or sinks for GHG (turf, trees, native grasslands, etc.). For example, the parameters may include golf course facility information (FIG. 4) a facility profile (FIG. 5), maintenance activity information (FIG. 6), water consumption or irrigation information (FIG. 7), fertilizer and pesticide usage information (FIG. 8), golf cart usage information (FIG. 9), facility energy consumption information (FIG. 10), turf/landscape information (FIG. 11), and PGR product usage information (FIG. 12). The parameters listed herein are not meant to limit embodiments of the present invention and are instead provided as an exemplary embodiment, particularly with respect to the facility being represented as a golf course facility.

By way of example, for a golf course facility landscape profile, in addition to the number of holes and total course acres, a profile may include information regarding forest density (low, medium, high, etc.) and the age and type of tree stand (deciduous, conifer, desert woodland, deciduous/conifer mix, etc.). Information regarding irrigation may include source of water (surface, ground, blend) and type of water (potable, semi-treated, storm or raw). Fertilizer information may include the type (ammonium nitrate, ammonium sulfate, calcium nitrate, urea, ESN, IBDN, methylene, urea, polymer coated urea, sulfur coated urea, UF, organic or other, etc.) and form (liquid, granular, fertigation). Turf information such as type (cool season, warm season, over seeded) and variety (bentgrass, perennial rye, Bermuda, rye, Kentucky blue, etc.) may also be collected

As mentioned previously, some of the parameters used to compile the query may be retrieved by the system and/or the computer device or by sensors, such that the user is not required to provide such information. That is, in some instances, the system and/or computer device may populate entry fields or otherwise provide certain parameters based on other information provided by the user or automatically. For example, geographic information systems (GIS) data, fuel rates/costs, energy consumption rates/costs associated with a commercial facility may be automatically retrieved. Accordingly, the user's input parameters may be compiled into a query that is used to ultimately provide greenhouse gas footprint information as it relates to the facility. According to some embodiments, such as pest input values may be input in the input entry fields 410 associated with the respective parameter. Such data can be obtained by ground scouting, by maintenance records, and/or other relevant information included in other systems or databases.

As shown in FIG. 12, one particular parameter that may be used to determine greenhouse gas footprint information associated with a facility is usage of a plant growth regulator (PGR) product such as the product trinexapac-ethyl sold under the trademark PRIMO MAXX®, available through Syngenta Crop Protection, Incorporated. PGR products may be used to prepare and strengthen turfgrass for extreme conditions by application thereof prior to the onset of stresses like heat, drought, disease and foot traffic, and therefore allow it to withstand ongoing stresses throughout the season. In this manner, PGR products save time and costs associated with fuel for facility mowing. Other products that improve plant health may also be employed in this regard. For example, products that enhance plant health and that also control diseases or other pests such as strobilurins including azoxystrobin sold under the trademark HERITAGE®, available through Syngenta Crop Protection, is suitable for use in accordance with the invention. This energy saving information also translates to reduced greenhouse gas/CO₂ emissions from the mowing equipment, thereby improving the greenhouse gas footprint of the facility. According to one embodiment, such an application of a PGR product may be incorporated into the greenhouse gas estimation algorithm to capture the actual facility savings by integrating fuel consumption savings based on the mowing reduction during the period of PGR product applications.

### Determining Step

The determining step 310 may comprise in one embodiment, for example, determining from the facility parameters a greenhouse gas emission estimate and/or a greenhouse gas reduction estimate, wherein the greenhouse gas emission estimate is indicative of an amount of emitted greenhouse gas associated with the commercial facility and wherein the greenhouse gas reduction estimate is indicative of an amount of greenhouse gas sequestered by the commercial facility. For example, the greenhouse gas emission estimate may be indicative of a gross greenhouse gas footprint estimate calculated based on the input parameters provided by the user. Further, the greenhouse gas reduction estimate may be indicative of an amount of greenhouse gas sequestered by the facility as calculated based on the input parameters provided by the user.

According to some embodiments, the greenhouse gas emission estimate and/or a greenhouse gas reduction estimate may be calculated to a first-order estimate. In one instance, the greenhouse gas emission estimate may be provided as a gross greenhouse gas footprint estimate, which represents the estimated amount of greenhouse gas (e.g., CO₂) emitted into the atmosphere to generate the energy input required to operate the facility over a predetermined duration of time. In one example, the gross greenhouse gas footprint estimate may be calculated by aggregating greenhouse gas emission estimates for the various parameters associated with the facility. For example, the gross greenhouse gas footprint estimate may be calculated by aggregating greenhouse gas emission estimates from maintenance activities related to fuel consumption, energy consumption to pump irrigation water, nitrous oxide generation from the use of synthetic fertilizers, energy consumption from golf cart usage, and clubhouse energy usage. That is, the gross greenhouse gas footprint estimate may be determined as an additive calculation of the individual emissions estimates for each parameter or input associated therewith. The usage of PGR products may not be typically used in calculating the gross greenhouse gas footprint estimate due to its greenhouse gas reduction is reflected in a reduction of total fuel consumption (i.e., reduced mowing).

As previously described, the greenhouse gas emissions estimate may be calculated by aggregating greenhouse gas emissions estimates for the various parameters associated with the facility. The following algorithms are provided as examples of an approach for determining greenhouse gas emission estimates for certain parameters associated with a facility and are not meant to limit the present disclosure.

### Example A

### Electricity Usage

Greenhouse gas emissions from electricity production vary widely across the United States, depending on the mix of power sources used by electricity providers. Embodiments of the present invention may use a U.S. state database to pull the appropriate emissions factors and cost rates per kilowatt-hour for the facility's area. According to the U.S. Environmental Protection Agency (EPA), 1.329 lbs of CO₂ is the national average produced for every kilowatt-hour (kWh) of electricity in the United States. This estimate considers mixed electricity sources including coal, oil and natural gas energy plants. The state level database utilized by embodiments of the present invention may also take into consideration renewable energy sources such as solar, hydro or wind.

As an example, consider an $8,000 annual electric bill to pump water on a golf course facility in North Carolina, wherein the emission estimate (($8,000/$0.0797 per kWh for NC Commercial Sector)×(1.297 lbs of CO₂ per kWh)) is 130,188 lbs of CO₂, which is equivalent to 59 metric tons of CO₂.

### Example B

### Fuel Usage

According to the U.S. EPA, one gallon of gas produces 19.4 lbs of CO₂, while one gallon of diesel gas produces 22.2 lbs of CO₂. As an example, consider 6400 gallons of gas and 1800 gallons of diesel gas consumed annually by a golf course facility, wherein the emission estimate for a gas engine ((6400 gallon of gas)×(19.4 lbs of CO₂ per gallon of gas)) is 124,160 lbs of CO₂, which is equivalent to 56 metric tons of CO₂, and wherein the emission estimate for a diesel engine ((1800 gallon of gas)×(22.2 lbs of CO₂ per gallon of gas)) is 39,960 lbs of CO₂, which is equivalent to 18 metric tons of CO₂.

### Example C

### Nitrous Oxide Generation from Fertilizer Usage

According to various sources, an energy conversion for direct N₂O emissions from fertilizers converted to CO₂ equivalents is (N applied annually (lbs N))×(emission coefficient from use of synthetic commercial fertilizers)×(1.571 lbs N₂O per lb)×(conversion factor for converting lbs of nitrous oxide to carbon dioxide equivalents). The extent to which this nitrous oxide emission/enhancement occurs may be site-specific, varying with temperature, soil conditions, fertilizer type, and crop type. Without exceptionally detailed information, it is generally not possible to estimate nitrous oxide emissions from agricultural sources to any degree of reliability higher than an order of magnitude. In this instance, a conservative approach was utilized for this value (1.0% for the emission coefficient). The atmospheric lifetime of N₂O is approximately 100 years, and its 100-year GWP is typically estimated to be 296 times that of CO₂.

As an example, consider 7000 lbs of nitrogen applied annually to a golf course facility, wherein the emission estimate ((7000 lbs of N applied annually)×(0.010)×(1.571 lbs N20/lb N)×(296 GWP factor)) is 32,551 lbs of CO₂, which is equivalent to 14.8 metric tons of CO₂.

As previously discussed, the input parameters may be used to determine a greenhouse gas reduction estimate indicative of an amount of greenhouse gas sequestered by the turf, vegetation (trees, plants), etc. of the facility. The following algorithm is provided as an example of an approach for determining the greenhouse gas reduction estimate for certain parameters associated with a facility and is not meant to limit the present disclosure.

### Example D

### Greenhouse Gas Sequestered

As an example, energy conversions for carbon sequestered by turf and trees on a golf course facility converted to CO₂ equivalents may be derived based on state level information or derivation. In this particular example, assume 86 acres of managed turf and 10 acres of urban forest over a 150 acre NC golf course facility, wherein the sequestered estimate for the turf (total managed course acreage×4,084 lbs CO₂ per acre per year=86 acres×4,084 lbs CO₂ per acre per year) is 351,224 lbs CO₂ per year, which is equivalent to 159 metric tons of CO₂, and wherein the sequestered estimate for the trees (total tree acreage×4,257 lbs CO₂ per acre per year=10 acres×4,257 lbs CO₂ per acre per year) is 42,570 lbs CO₂ per year, which is equivalent to 19 metric tons of CO₂.

As previously noted, in some instances the parameters used to determine the greenhouse gas emission and reduction estimates may be retrieved from sources other than the user. For example, determining the greenhouse gas emissions associated with electricity usage may require accessing a state database to pull the appropriate emissions value per kilowatt-hour for the facility's area. In this regard, input of the input parameters by the user may be optional in some instances. That is, according to some embodiments, the input parameters associated with the facility may be provided by a third-party or otherwise captured from some other source. In this regard, the input parameters may be automatically provided to the system such that the user is not required to actively input such information, thereby ensuring to the user that the related information is timely and accurate.

Optionally, the method may further include a determining step comprising in one embodiment, for example, determining a net greenhouse gas footprint estimate from the determined greenhouse gas emission estimate and the determined greenhouse gas reduction estimate. The net greenhouse gas footprint estimate is indicative of the overall greenhouse gas footprint of the facility and may be determined by taking the difference between the determined greenhouse gas emission estimate and the determined greenhouse gas reduction estimate.

Also, the method may further include an optional determining step comprising in one embodiment, for example, determining a PGR reduction estimate indicative of the reduction in greenhouse gas emissions at the facility attributed to application of a PGR product. The following algorithm is provided as an example of an approach for determining the PGR reduction estimate for certain parameters associated with a facility and is not meant to limit the present disclosure.

### Example E

### Fuel Consumption Reduction Due to PGR Applications

As an example, assume 7000 gallons of gas and 3000 gallons of diesel utilized for mowing activities annually, wherein a PGR product is applied over a four month period and the course is mowed over a six month period. Further, assume that application of the PGR product provides a 25% reduction in mowing for the fairways and greens, as well as a 10% reduction on the tee box area. Finally, assume the course is comprised of the following managed acreage: 3 acres of tee box area, 3 acres of greens, 30 acres of fairways, and 51 acres of rough, wherein the amount of reduced emissions from use of a PGR product is calculated according to the following algorithm:

(((Total Annual Gas Consumption for Mowing*CO₂ Rate for Gas)+(Total Annual Diesel Consumption for Mowing*CO₂ Rate for Diesel))×(Months Primo Applied/Months Course Mowed)×% mowing reduction for fairway×(area of fairway/total area mowed))+((Total Annual Gas Consumption for Mowing*CO₂ Rate for Gas)+(Total Annual Diesel Consumption for Mowing*CO₂ Rate for Diesel))×(Months Primo Applied/Months Course Mowed)×% mowing reduction for tees×(area of tees/total area mowed))+((Total Annual Gas Consumption for Mowing*CO₂ Rate for Gas)+(Total Annual Diesel Consumption for Mowing*CO₂ Rate for Diesel))×(Months Primo Applied/Months Course Mowed)×% mowing reduction for greens×(area of greens/total area mowed)).

In this particular example, the amount of reduced emissions from use of a PGR product ((7000 gallons of gas*19.4 lbs of CO₂ per gallon of gas)+(3000 gallons of diesel*22.2 lbs of CO₂ per gallon of diesel)*(4 month application of Primo/6 months of mowing)*0.25 mowing reduction for fairway*(30 acres of fairway/87 acres managed turf)+((7000 gallons of gas*19.4 lbs of CO₂ per gallon of gas)+(3000 gallons of diesel*22.2 lbs of CO₂ per gallon of diesel)*(4 month application of Primo/6 months of mowing)*0.10 mowing reduction for tees*(3 acres of tees/87 acres managed turf)+((7000 gallons of gas*19.4 lbs of CO₂ per gallon of gas)+(3000 gallons of diesel*22.2 lbs of CO₂ per gallon of diesel)*(4 month application of Primo/6 months of mowing)*0.25 mowing reduction for greens*(3 acres of greens/87 acres managed turf) is 12,842 lbs CO₂ per year, which is equivalent to 5.8 metric tons of CO₂ emissions reduced from application of the PGR product.

Further, the method may also optionally include a determining step comprising in one embodiment, for example, determining a greenhouse gas footprint equivalent corresponding to the determined net greenhouse gas footprint estimate. In one embodiment, the greenhouse gas footprint equivalent is indicative of greenhouse gas emissions from a comparative source, wherein the greenhouse gas footprint equivalent is used to provide a comparison to the net greenhouse gas footprint estimate in terms more familiar to the user.

### Example F

### Equivalence Comparison

The equivalence comparison is meant to demonstrate the facility's net greenhouse gas footprint relative to benchmarks that the user can relate to in his/her daily life. That is, it can sometimes be difficult to visualize to what a “metric ton of carbon dioxide” equates. According to one embodiment, the equivalence comparison may utilize the emission spectrum for the average home in the United States and the average passenger vehicle in the United States. Thus, embodiments of the present invention may translate rather difficult to understand statements into more common terms, such as, for example “is equivalent to avoiding the carbon dioxide emissions of X number of cars annually.” Such an equivalency benchmark may be useful in communicating a greenhouse gas reduction strategy, reduction targets, or other initiatives aimed at reducing greenhouse gas emissions.

As an example, assume that the average home in the United States emits approximately 41,500 lbs CO₂ annually or 18.8 metric tons of CO₂ equivalents per year (considers transportation, electricity, heating and waste for household of two people). Further, assume that the average passenger vehicle in the United States (19.7 mpg and driven 11,856 miles) generates approximately 12,100 lbs CO₂ per vehicle per year or 5.5 metric tons of CO₂ equivalents per year. As an example for a golf course facility, assume a net greenhouse gas footprint estimate of 150 metric tons of CO₂ annually, wherein the net greenhouse gas footprint estimate is calculated to be equivalent to greenhouse gas emissions from eight (8) U.S. homes (Net Carbon Footprint of the Golf Course/Carbon Footprint of Average U.S. Home; 150 metric tons of CO₂ per year/18.8 metric tons), and wherein the net greenhouse gas footprint estimate is calculated to be equivalent to greenhouse gas emissions from twenty-seven (27) U.S. passenger (Net Carbon Footprint of the Golf Course/Carbon Footprint of Average U.S. Vehicle; 150 metric tons of CO₂ per year/5.5 metric tons).

### Providing Step

The providing step 320 may comprise in one embodiment, for example, providing, notifying, or otherwise displaying an indicia of the greenhouse gas footprint estimate, the greenhouse gas reduction estimate, and/or any other related greenhouse gas footprint information (e.g., the net greenhouse gas footprint estimate, the PGR reduction estimate, the greenhouse gas footprint equivalent) to the user in direct response to the query. The indicia of the greenhouse gas footprint estimate, the greenhouse gas reduction estimate, and/or other related information may be displayed on a display screen associated with the computer device of the user. In other instances, the indicia of the greenhouse gas footprint estimate, the greenhouse gas reduction estimate, and/or other related information may be printed on a paper-type medium for the user's viewing. In other embodiments, the greenhouse gas footprint estimate, the greenhouse gas reduction estimate, and/or other related information may be communicated or otherwise provided to the user in any suitable manner, such as, for example, generating a report capable of being transmitted to the user, wherein the report may include a sustainable management strategy capable of being implemented by the facility to reduce the determined greenhouse gas footprint estimate thereof. In other instances, the user may achieve compliance with a certification program through use of embodiment of the present invention, whereby the user may be provided with a certificate acknowledging such compliance.

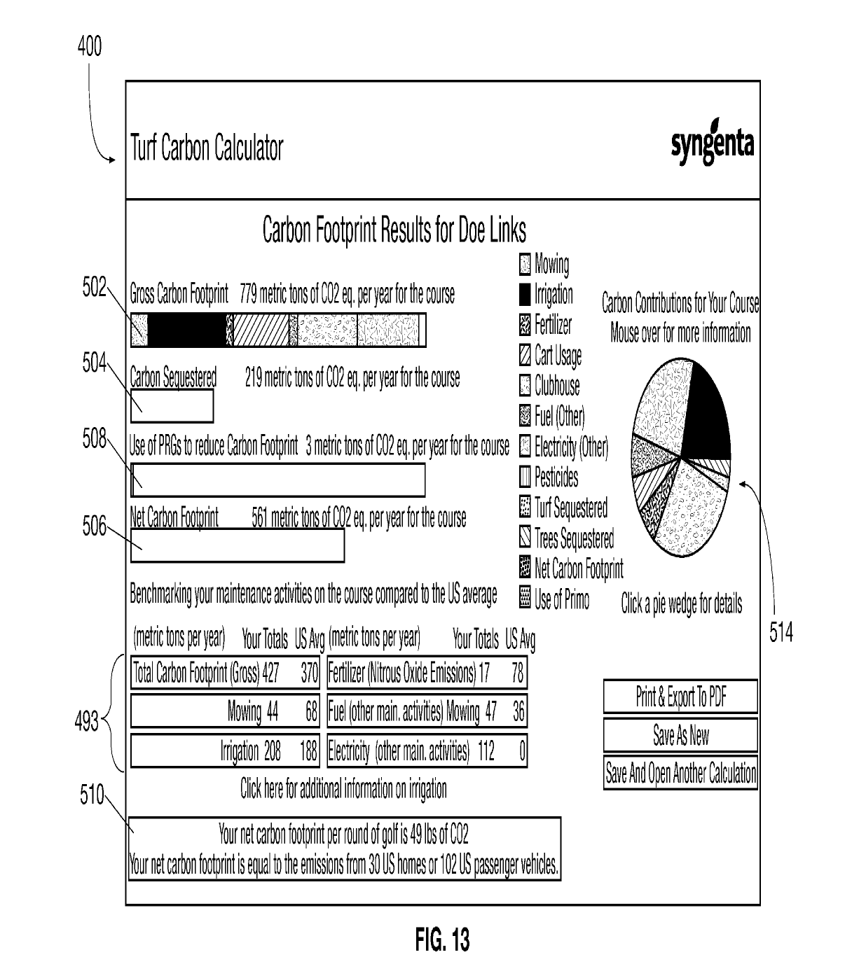

In any instance, the user may be provided with indicia of the greenhouse gas footprint information for a particular facility. As previously mentioned, in some instances, the user may be provided with the greenhouse gas footprint information from comparative sources (e.g., emissions associated with homes, emissions associated with passenger vehicles) so as to facilitate a comparison therebetween with respect to a familiar comparative item. The greenhouse gas footprint information may be provided to the user via the display 400 (see FIGS. 13-15 and 25, for example, depicting an Internet webpage that may be accessed by a user according to one embodiment of the present invention, for viewing greenhouse gas footprint information associated with a facility). For example, the user may be provided with the greenhouse gas footprint information as a gross greenhouse footprint estimate 502, a greenhouse gas sequestered estimate 504, a net greenhouse gas footprint estimate 506, and/or a reduced greenhouse gas estimate 508 attributed to a PGR product, and/or a greenhouse gas footprint equivalent 510. In this manner, the user may be provided with real-time information that permits an evaluation of the environmental impact with respect to the facility. In some embodiments, the user may be provided with a graphical representation (e.g., pie chart, bar graph) illustrating the greenhouse gas footprint information via the display 400 in response to the user inputted parameters. For example, the user may be provided with an interactive pie chart showing the greenhouse gas contributions for various parameters associated with the facility, wherein “mousing over” a particular portion of the pie chart provides the user with information specific to the parameter associated with that particular portion of the pie chart.

Accordingly, the method, system, and device in accordance with embodiments of the present invention may be used to provide greenhouse gas footprint information, and, more specifically, to provide greenhouse gas footprint information associated with a commercial or municipal facility such that an evaluation of the facility may be made regarding the environmental impact thereof, while also providing information for adjusting various parameters to reduce the determined environmental impact.

The following examples that relate to a golf course facility are not meant to limit the present disclosure, but are provided to exemplify changes to certain facility parameters, products, or procedures that may be informed by the greenhouse gas footprint information provided by the present invention, which changes provide a technical effect with respect to an environmental impact associated with the facility.

### Example G

### Water/Irrigation

Choose turfgrass varieties which require less water
Conduct a site assessment to assure the irrigation system is configured and functioning properly
Use drought-resistant plants and native vegetation to offset irrigation and maintenance requirements (xeriscape)
Use mulch in landscaped areas
If feasible, eliminate overseeding of playable areas
Make sure irrigation system is up-to-date (computer control system) and has individual sprinkler head control capability (retrofit sprinkler heads if possible).
Achieve better water distribution through use of wetting agents
Explore areas to use storm water, tail water or reclaimed water for maintenance purposes
Plan irrigation for off-peak times, normally late evening to early mornings
Rely on weather stations to collect current ET, rain, wind and/or soil moisture measurements in order to respond to real-time conditions.
Use GPS/GIS to control hole specific watering
Hand water selected areas
Design a monthly irrigation budget
Rainfall should be carefully tracked with rain sensor shutoff devices in place
Establish a recovery system for irrigation runoff
Use proper soil aeration to improve water infiltration
Modify fertilizer management program to reduce watering needs.
Fix problem leaks promptly
Conduct irrigation audits to evaluate the distribution efficiency and quantity consumed (install flow meters). Potential to reduce irrigation and energy consumption.

### Example H

### Mowing

Adjusting mowing height not only decreases mowing frequency but also leads to less water use, stress on the plants and spread of weeds
Maintenance costs can be reduced significantly by applying plant growth regulators (PGRs) to the course
Redesign and manage fairways, semi-roughs and roughs to save costs through reduction in mowed areas and mowing frequency.
Sharpened mowing blades to save time and cut down on drag.
Clippings, if collected, should be composted on the course property rather than taken to landfills

### Example I

### Fertilizer Management

Audit of the course's soil and turfgrass traits to match with the most effective fertilizer regime tailored for course specific turf.
Implement fertigation if and where feasible
Use lower fertilizer rates for older (mature) healthy turfs that have been properly managed for many years and receive low to modest amounts of traffic (play).
Know your turfgrass cultivars. New drought resistant varieties of turfgrass may need less fertilizer and nutrients.
Fertilizing late in the season (September through November) of the previous year reduces or eliminates the need for fertilizer in the spring, reduces the frequency of mowing, and improves drought resistance
To avoid excessive growth approaching the stressful summer months, use a slowly available source of nitrogen (sulfur-coated urea, polymer-coated urea, IBDU, methylene urea, or natural organic-based fertilizers)

### Example J

### Pesticide Management

Keep detailed records of pest activity on the course and corresponding pesticide applications with routine scouting.
Establish an Integrated Pest Management (IPM) Program
Follow the manufacturer's label for rates, timing and placement.
Determine the feasibility of applying pesticides through chemigation to save time, money and energy.

### Example K

### Equipment Maintenance

Ensure that maintenance equipment is serviced routinely.
Purchase new equipment in consideration of fuel efficiency, service life and maintenance requirements which may result in long-term savings.
Proper disposal and recycling of engine fluids

### Example L

### Maintenance Facility

Train employees in simple techniques to reduce energy and water use
Regulate energy use as much as possible to avoid peak usage hours
Consider energy efficient lighting and take advantage of natural light wherever possible
Make sure all lights, fans, compressors and equipment are turned “off” when not in use.

### Example M

### Carts

Service the cart fleet regularly for most efficient performance.
Investigate alternative power sources like converting to electric-powered carts from gas or solar charging of cart batteries.

### Example N

### Clubhouse

Train employees in simple techniques to reduce energy and water use
Regulate energy use as much as possible to avoid peak usage hours
Explore alternative solar, hydro, wind and geothermal energy sources
For maximum efficiency, thermostats should be set on 78° F. year-round
Change out incandescent light bulbs. Switch to compact fluorescent lights (CFLs) and other efficient lamps. Installing dimmer switches also helps.
Install properly insulated windows.
Assess insulation within the clubhouse (What's the R factor?)
Consider Energy Star Appliances and Office Equipment.
Buy recycled office supplies (i.e. paper).
Take advantage of energy reduction features on office equipment (i.e. computers and copiers).
Service and update HVAC equipment as needed to achieve maximum energy efficiency
Replace or clean air filters every month. Clogged filters contribute significantly to energy costs.
Repair any leaks in faucets or plumbing pipes promptly. The water loss from a leak can be significant.
Retrofit toilets with the dual flush mechanism to conserve additional water.

Having now described the greenhouse gas evaluation system for providing greenhouse gas footprint information used in evaluating the environmental impact of a facility according to various parameters associated therewith, an exemplary greenhouse gas evaluation method, system, and device in accordance with embodiments of the present invention will now be provided in relation to a golf course facility. In one example, the user, such as a golf course superintendent, may determine various parameters associated with the golf course facility, wherein the parameters are used to calculate greenhouse gas footprint information associated with the golf course facility. The user may then input such parameters into the facility input entry fields 410 via a keyboard device. For example, as shown in FIG. 4, the user may input or otherwise provide course information parameters 420 associated with the golf course facility, such as, for example, superintendent's name 421, golf course facility name 422, U.S. state in which the golf course facility is located 423, ZIP code 424, preferred units of measure 425, and country in which the golf course facility is located 426.

Further, as shown in FIG. 5, the user may input or otherwise provide landscape profile parameters 430 associated with the golf course facility, such as, for example, number of golf holes 431, total course acreage 432, total managed acreage 433, acreage of non-turfgrass landscapes 434, tree stand information 435, and forest density 436. In addition, as shown in FIG. 6, the user may input or otherwise provide maintenance activity parameters 440 associated with the golf course facility, such as, for example, fuel consumption associated with mowing 441, number of months turfgrass is mowed 442, fuel consumption associated with activities other than mowing 443 (e.g., pesticide/fertilizer applications), and energy consumption attributed to maintenance activities 444 (e.g., fans on greens, maintenance sheds). Also, as shown in FIG. 7, the user may input or otherwise provide irrigation parameters 450 associated with the golf course facility, such as, for example, energy consumption 451, fuel consumption 452, water consumption 453, water source 454, and water type 455. Furthermore, as shown in FIG. 8, the user may input or otherwise provide fertilizer/pesticide parameters 460 associated with the golf course facility, such as, for example, amount of fertilizer 461, form of fertilizer 462, fertilizer application method 463, and amount of pesticides 464.

Additionally, as shown in FIG. 9, the user may input or otherwise provide golf cart parameters 470 associated with the golf course facility, such as, for example, energy consumption 471 (electricity/gas) and cart usage over a predetermined duration 472. Further, as shown in FIG. 10, the user may input or otherwise provide clubhouse parameters 475 associated with the golf course facility, such as, for example, energy consumption/cost 476 and water usage 477. Also, as shown in FIG. 11, the user may input or otherwise provide turfgrass/soil parameters 480 associated with the golf course facility, such as, for example, turf variety for greens 481, turf variety for tees 482, turf variety for fairways 483, turf duration 484, percentage soil organic matter 485, and soil textures 486. Furthermore, as shown in FIG. 12, the user may input or otherwise provide PGR parameters 490 associated with the golf course facility, such as, for example, usage 491, application area percentage 492, frequency of applications 493, and mowing reduction 494.

Using these various input parameters, some of which may be automatically provided (as described previously), a query may be compiled/generated and submitted for determination of the greenhouse gas footprint information associated with the facility, according to, for example, the algorithms previously described. Accordingly, the indicia of the determined greenhouse gas footprint information may then be displayed on the display 400 to the user in direct response to the query, as shown in FIG. 13. For example, the gross greenhouse footprint estimate 502, greenhouse gas sequestered estimate 504, net greenhouse gas footprint estimate 506, reduced greenhouse gas estimate 508 attributed to a PGR product, and greenhouse gas footprint equivalent 510 may be provided on the display 400. Further, in some instances, comparison indicia 512 may be provided such that the user can compare the greenhouse gas footprint information totals to a national average. In addition, a graphical display 514 may be provided to illustrate the make-up of the gross greenhouse footprint estimate 502 in regard to the various parameters associated with the golf course facility. As such, the golf course superintendent may be provided with information used to evaluate the overall environmental impact of the golf course facility. Of course, one of ordinary skill in the art will recognize that facility parameters and other variables associated with this example may be altered to suitable preferences by the user, and such an example is not meant to limit the disclosure herein in any manner. Further, one of ordinary skill will recognize that the described embodiments may be adapted to European standards (i.e., metric units) or other foreign standards such that the present invention may be implemented throughout the world.

Various method and computer program product embodiments of the present invention may also provide a “turn-key” greenhouse gas footprint evaluation program for the user. For example, in some embodiments, the providing step 320 may comprise providing the greenhouse gas footprint information to the user via an internet website and/or other visual display 400 that includes a logo, color scheme, background, trademarks, and/or trade dress that represents an entity providing one or more greenhouse gas emission reduction or sequestration strategies being considered by the user.

### EXAMPLES

The following examples illustrate further some of the aspects of the invention but are not intended to limit its scope.

### Example 1

Query Step - Collect facility parameters associated with a golf course No. 1

| Golf Course Landscape Profile | | | | |
|---|---|---|---|---|
| How many holes are at your | 18 | | | |
| facility? | | | | |
| What is the total course | 229 | | | |
| acreage? | | | | |
| What's the total managed | Greens: | 5 | Tees: | 5 |
| acreage? | Fairways: | 32 | Rough: | 57 |
| What are the acres of the | Trees: | 10 | Grasslands: | 22 |
| following non-turfgrass | Ponds: | 70 | Shrublands: | 13 |
| landscapes on the course? | Other: | 15 | | |
| Maintenance Activities | | | | |
| How many gallons of fuel used | Gas: | 3,968 | | |
| annually for mowing? | Diesel: | 5,441 | | |
| Number of months that greens, | 12 | | | |
| tees and fairways are mowed? | | | | |
| How many gallons of gas and | Gas: | 5,669 | | |
| diesel fuel are used annually for | Diesel: | 605 | | |
| other maintenance activities | | | | |
| (i.e. Pesticide or fertilizer | | | | |
| applications or other ground | | | | |
| maintenance)? | | | | |
| What's the annual cost of | $12,300 | | | |
| electricity associated with | | | | |
| maintenance activities (i.e. | | | | |
| Maintenance sheds, fans on the | | | | |
| greens or other)? | | | | |
| Irrigation | | | | |
| Estimated annual cost of | $48,359 | | | |
| electricity to irrigate the course: | | | | |
| Estimated annual gallons of | -0- | | | |
| diesel fuel used to irrigate the | | | | |
| course: | | | | |
| Estimated amount of water | 120.0 | | | |
| utilized on the course (millions | | | | |
| of gallons) | | | | |
| What is the source of the water? | Blend | | | |
| What is the water type? | Raw | | | |
| Fertilizers and Pesticides | | | | |
| | | | Amount | |
| | | Type | (lbs · N) | Form |
| How many pounds of nitrogen | Fertilizer1 | Other | 4,000 | Liquid |
| are applied annually to your | Fertilizer2 | Polymercoated | 30,000 | Granular |
| course? | | Ureas | | |
| Estimate the percentage of the | 75 | | | |
| course's nutrient management | | | | |
| program that utilizes either | | | | |
| controlled release fertilizers or | | | | |
| fertilizers with stabilizers? | | | | |
| Estimate the percentage of | 95 | | | |
| grasscycling implemented on | | | | |
| the course (returning of | | | | |
| clippings to the managed turf | | | | |
| areas)? | | | | |
| How many pounds of pesticides | 750 | | | |
| (a.i.) are applied annually to | | | | |
| your course? | | | | |
| Golf Carts | | | | |
| What is the estimated annual usage | Electricity | $14,500 | | |
| of electricity or gas for cart | Gas (gals.) | 60 | | |
| operations? | | | | |
| What is the number of rounds | 10,320 | | | |
| played annually on golf carts? | | | | |
| Clubhouse | | | | |
| What is the estimated annual cost | $55,000 | | | |
| of electricity for clubhouse | | | | |
| operations? | | | | |
| What is the estimated annual | 764,800 | | | |
| amount of natural gas for | | | | |
| clubhouse operations (cu. ft?) | | | | |
| What is the estimated annual | -0- | | | |
| amount of fuel oil for clubhouse | | | | |
| operations (gals.)? | | | | |
| How many gallons of propane are | | | | |
| used annually by the course? | | | | |
| How much potable water is used | 1 | | | |
| annually by the clubhouse (mil. of | | | | |
| gals.)? | | | | |
| Turf Varieties and Soil Properties | | | | |
| What is the most common turf type | Warm Season | | | |
| found on your course? | | | | |
| Please select the permanent turf | Bermuda | | | |
| varieties that are found on your | | | | |
| greens: | | | | |
| Please select the permanent turf | Bermuda | | | |
| varieties that are found on your | | | | |
| trees: | | | | |
| Please select the permanent turf | Bermuda | | | |
| varieties that are found on your | | | | |
| fairways | | | | |
| How many years has the turf been | 5 | | | |
| established? | | | | |
| Input most recent % soil organic | Fairways | 4.0 | | |
| matter: | Greens | 2.5 | | |
| Please select the soil textures that | Greens | Sand | | |
| are found on your course: | Fairways | Sandy Loam | | |
| PGRs | | | | |
| Do you utilize plant growth | Yes | | | |
| regulators on your course? | | | | |
| What percent of PGRs are applied | Fairways | 60 | | |
| to the following? | Greens | 35 | | |
| | Tees | 5 | | |
| How frequently are PGRs applied? | 2 | | | |
| (# applications per month) | | | | |
| How many months of the year are | 7 | | | |
| PGRs applied? | | | | |
| What percentage reduction in | Fairways | 15 | | |
| mowing is noted to the following? | Greens | -0- | | |
| | Tees | 15 | | |

Determining Step - determine GHG footprints in accordance with the algorithms of
Examples A-F
Providing/Displaying step - provide indicia - (determined from query data based on
mowing, irrigation, fertilizer, cart usage, clubhouse, fuel, electricity, pesticides, turf
sequestration, tree sequestration, use of PGR (Primo))
Summary of Results for golf course no. 1

| | |
|---|---|
| Gross Carbon Footprint: | 1,150 metric tons of CO₂ per year |
| Carbon Storage and Sequestration: | 308 metric tons of CO₂ per year |
| Use of PGRs to Reduce Carbon Footprint: | 4 metric tons of CO₂ per year |
| Net Carbon Footprint: | 843 metric tons of CO₂ per year |

Benchmark maintenance activities to US Average (w/o clubhouse or cart use data)

| | Totals | US Avg |
|---|---|---|
| Total Carbon Footprint (Gross) | 664 | 180 |
| Mowing | 90 | 34 |
| Irrigation | 308 | 94 |
| Pesticides | 6 | 6 |
| Fertilizer | 126 | 39 |
| Fuel (Other main. activities) | 56 | 7 |
| Electricity (other main. Activities) | 78 | 0 |

Course No. 1 net carbon footprint per round of golf is 180 lbs. of CO₂.
Course No. 1 net carbon footprint is equal to the emissions from 45 US homes or 153 US
passenger vehicles.

Based on these reported indicia a user may decide to alter management practices associated with a clubhouse in accordance with Example N.

### Example 2

Query Step - Collect facility parameters associated with a golf course No. 2

| Golf Course Landscape Profile | | | | |
|---|---|---|---|---|
| How many holes are at your | 18 | | | |
| facility? | | | | |
| What is the total course acreage? | 104 | | | |
| What's the total managed acreage? | Greens: | 5 | Tees: | 5 |
| | Fairways: | 40 | Rough: | 54 |
| What are the acres of the following | Trees: | 26 | Grasslands: | 25 |
| non-turfgrass landscapes on the | Ponds: | 13 | Shrublands: | 0 |
| course? | Other: | 0 | | |
| Maintenance Activities | | | | |
| How many gallons of fuel used | Gas: | 950 | | |
| annually for mowing? | Diesel: | 4,500 | | |
| Number of months that greens, tees | 12 | | | |
| and fairways are mowed? | | | | |
| How many gallons of gas and | Gas: | 3,722 | | |
| diesel fuel are used annually for | Diesel: | 1,321 | | |
| other maintenance activities (i.e. | | | | |
| Pesticide or fertilizer applications | | | | |
| or other ground maintenance)? | | | | |
| What's the annual cost of | $8,000 | | | |
| electricity associated with | | | | |
| maintenance activities (i.e. | | | | |
| Maintenance sheds, fans on the | | | | |
| greens or other)? | | | | |
| Irrigation | | | | |
| Estimated annual cost of electricity | $352,400 | | | |
| to irrigate the course: | | | | |
| Estimated annual gallons of diesel | -0- | | | |
| fuel used to irrigate the course: | | | | |
| Estimated amount of water utilized | 390.0 | | | |
| on the course (millions of gallons) | | | | |
| What is the source of the water? | Ground water | | | |
| What is the water type? | Storm water | | | |
| Fertilizers and Pesticides | | | | |
| | | | Amount | |
| | | Type | (lbs · N) | Form |
| How many pounds of nitrogen are | Fertilizer1 | Ammonium | 22,000 | Granular |
| applied annually to your course? | | Sulfate | | |
| | Fertilizer2 | Ammonium | 1,100 | Liquid |
| | | Nitrate | | |
| Estimate the percentage of the | 5 | | | |
| course's nutrient management | | | | |
| program that utilizes either | | | | |
| controlled release fertilizers or | | | | |
| fertilizers with stabilizers? | | | | |
| Estimate the percentage of | 85 | | | |
| grasscycling implemented on the | | | | |
| course (returning of clippings to | | | | |
| the managed turf areas)? | | | | |
| How many pounds of pesticides | 131 | | | |
| (a.i.) are applied annually to your | | | | |
| course? | | | | |
| Golf Carts | | | | |
| What is the estimated annual usage of | Electricity | $6,000 | | |
| electricity or gas for cart operations? | Gas (gals.) | 0 | | |
| What is the number of rounds played | 43,000 | | | |
| annually on golf carts? | | | | |
| Clubhouse | | | | |
| What is the estimated annual cost of | $7,831 | | | |
| electricity for clubhouse operations? | | | | |
| What is the estimated annual amount | -0- | | | |
| of natural gas for clubhouse operations | | | | |
| (cu. ft?) | | | | |
| What is the estimated annual amount | -0- | | | |
| of fuel oil for clubhouse operations | | | | |
| (gals.)? | | | | |
| How many gallons of propane are | -0- | | | |
| used annually by the course? | | | | |
| How much potable water is used | -0- | | | |
| annually by the clubhouse (mil. of | | | | |
| gals.)? | | | | |
| Turf Varieties and Soil Properties | | | | |
| What is the most common turf type | Overseeded | | | |
| found on your course? | | | | |
| Please select the permanent turf | Bermuda | | | |
| varieties that are found on your | | | | |
| greens: | | | | |
| Please select the permanent turf | Bermuda | | | |
| varieties that are found on your trees: | | | | |
| Please select the permanent turf | Bermuda | | | |
| varieties that are found on your | | | | |
| fairways | | | | |
| How many years has the turf been | 10 | | | |
| established? | | | | |
| Input most recent % soil organic | Fairways | 1.0 | | |
| matter: | Greens | 1.5 | | |
| Please select the soil textures that are | Greens | Sand | | |
| found on your course: | Fairways | Sand | | |
| PGRs | | | | |
| Do you utilize plant growth regulators | Yes | | | |
| on your course? | | | | |
| What percent of PGRs are applied to | Fairways | 80 | | |
| the following? | Greens | 10 | | |
| | Tees | 10 | | |
| How frequently are PGRs applied? (# | 2 | | | |
| applications per month) | | | | |
| How many months of the year are | 10 | | | |
| PGRs applied? | | | | |
| What percentage reduction in mowing | Fairways | 45 | | |
| is noted to the following? | Greens | 45 | | |
| | Tees | 50 | | |

Determining Step - determine GHG footprints in accordance with the algorithms of
Examples A-F
Providing/Displaying step - provide indicia - (determined from query data based on
mowing, irrigation, fertilizer, cart usage, clubhouse, fuel, electricity, pesticides, turf
sequestration, tree sequestration, use of PGR (Primo))
Summary of Results for golf course no. 2

| | |
|---|---|
| Gross Carbon Footprint: | 861 metric tons of CO₂ per year |
| Carbon Storage and Sequestration: | 312 metric tons of CO₂ per year |
| Use of PGRs to Reduce Carbon Footprint: | 8 metric tons of CO₂ per year |
| Net Carbon Footprint: | 549 metric tons of CO₂ per year |

Benchmark maintenance activities to US Average (w/o clubhouse or cart use data)

| | Totals | US Avg |
|---|---|---|
| Total Carbon Footprint (Gross) | 836 | 180 |
| Mowing | 54 | 34 |
| Irrigation | 635 | 94 |
| Pesticides | 1 | 6 |
| Fertilizer | 86 | 39 |
| Fuel (Other main. activities) | 46 | 7 |
| Electricity (other main. Activities) | 14 | 0 |

Course No. 2 net carbon footprint per round of golf is 28 lbs. of CO₂.
Course No. 2 net carbon footprint is equal to the emissions from 29 US homes or 100 US
passenger vehicles.

Based on these reported indicia a user may decide to alter management practices associated with an irrigation regime in accordance with Example G.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer device adapted for interaction with a user and configured to provide greenhouse gas footprint information associated with one of a commercial and municipal facility, the computer device comprising:
a processing portion for receiving a query from a user, the query being associated with a plurality of facility parameters associated with one of a commercial and municipal facility;
a processing portion for determining from the facility parameters at least one of a greenhouse gas emission estimate indicative of an amount of emitted greenhouse gas associated with the facility and a greenhouse gas reduction estimate indicative of an amount of greenhouse gas sequestered by the facility; and
a processing portion for providing an indicia of at least one of the greenhouse gas emission estimate and the greenhouse gas reduction estimate via a display device in direct response to the query, so as to provide greenhouse gas footprint information capable of use in evaluating an environmental impact of the facility.

2. A computer device according to claim 1 wherein the processing portion for receiving a query from a user is further configured to receive a query associated with a plurality of facility parameters associated with a facility profile, energy consumption, maintenance activity and combinations thereof.

3. A computer device according to claim 1 further comprising a processing portion for determining a net greenhouse gas footprint estimate from the difference between the greenhouse gas emission estimate and the greenhouse gas reduction estimate.

4. A computer device according to claim 3 further comprising a processing portion for determining a greenhouse gas footprint equivalent corresponding to the determined net greenhouse gas footprint estimate, the greenhouse gas footprint equivalent being indicative of greenhouse gas emissions from a comparative source, wherein the processing portion for providing an indicia of at least one of the greenhouse gas emission estimate and the greenhouse gas reduction estimate is further configured to provide an indicia of the greenhouse gas footprint equivalent, so as to provide a comparison to the user via the display device.

5. A computer device according to claim 1 wherein the processing portion for determining from the facility parameters at least one of a greenhouse gas emission estimate and a greenhouse gas reduction estimate is configured to determine from the facility parameters at least one of a greenhouse gas emission estimate and a greenhouse gas reduction estimate based on greenhouse gas emissions or equivalents thereof.

6. A computer device according to claim 1 wherein the processing portion for receiving a query from a user is further configured to receive a query associated with a plurality of facility parameters defined over a predetermined duration of time.

7. A computer device according to claim 1 further comprising a processing portion for generating a report capable of being transmitted to the user, the report including a sustainable management strategy capable of being implemented to reduce the determined greenhouse gas emission estimate of the facility.

8. An intermediary computer device configured to implement a system for providing greenhouse gas footprint information associated with one of a commercial and municipal facility, the intermediary computer device being configured to be in communication with a computer network so as to be capable of communicating with a discrete computer device adapted to be used by the user, said intermediary computer device comprising:
a processing portion for receiving a query from a user, the query being associated with a plurality of facility parameters associated with one of a commercial and municipal facility;
a processing portion for determining from the facility parameters at least one of a greenhouse gas emission estimate indicative of an amount of emitted greenhouse gas associated with the facility and a greenhouse gas reduction estimate indicative of an amount of greenhouse gas sequestered by the facility; and
a processing portion for providing an indicia of at least one of the greenhouse gas emission estimate and the greenhouse gas reduction estimate via a display device in direct response to the query, so as to provide greenhouse gas footprint information capable of use in evaluating an environmental impact of the facility.

9. An intermediary computer device according to claim 8 wherein the processing portion for receiving a query from a user is further configured to receive a query associated with a plurality of facility parameters associated with a facility profile, energy consumption, maintenance activity and combinations thereof.

10. An intermediary computer device according to claim 8 further comprising a processing portion for determining a net greenhouse gas footprint estimate from the difference between the greenhouse gas emission estimate and the greenhouse gas reduction estimate.

11. An intermediary computer device according to claim 10 further comprising a processing portion for determining a greenhouse gas footprint equivalent corresponding to the determined net greenhouse gas footprint estimate, the greenhouse gas footprint equivalent being indicative of greenhouse gas emissions from a comparative source, wherein the processing portion for providing an indicia of at least one of the greenhouse gas emission estimate and the greenhouse gas reduction estimate is further configured to provide an indicia of the greenhouse gas footprint equivalent, so as to provide a comparison to the user via the display device.

12. An intermediary computer device according to claim 8 wherein the processing portion for determining from the facility parameters at least one of a greenhouse gas emission estimate and a greenhouse gas reduction estimate is configured to determine from the facility parameters at least one of a greenhouse gas emission estimate and a greenhouse gas reduction estimate based on greenhouse gas emissions or equivalents thereof.

13. An intermediary computer device according to claim 8 wherein the processing portion for receiving a query from a user is further configured to receive a query associated with a plurality of facility parameters defined over a predetermined duration of time.

14. An intermediary computer device according to claim 8 further comprising a processing portion for generating a report capable of being transmitted to the user, the report including a sustainable management strategy capable of being implemented to reduce the determined greenhouse gas emission estimate of the commercial facility.

15. A system for providing greenhouse gas footprint information associated with one of a commercial and municipal facility, said system comprising:
a first computer device configured to be in communication with a computer network, the first computer device comprising:
a processing portion for receiving a query from a user, the query being associated with a plurality of facility parameters associated with one of a commercial and municipal facility;
a processing portion for determining from the facility parameters at least one of a greenhouse gas emission estimate indicative of an amount of emitted greenhouse gas associated with the facility and a greenhouse gas reduction estimate indicative of an amount of greenhouse gas sequestered by the facility; and
a processing portion for providing an indicia of at least one of the greenhouse gas emission estimate and the greenhouse gas reduction estimate via a display device in direct response to the query, so as to provide greenhouse gas footprint information capable of use in evaluating an environmental impact of the facility.

16. A system according to claim 15 wherein the processing portion for receiving a query from a user is further configured to receive a query associated with a plurality of facility parameters associated with a facility profile, energy consumption, maintenance activity and combinations thereof.

17. A system according to claim 15 further comprising a processing portion for determining a net greenhouse gas footprint estimate from the difference between the greenhouse gas emission estimate and the greenhouse gas reduction estimate.

18. A system according to claim 17 further comprising a processing portion for determining a greenhouse gas footprint equivalent corresponding to the determined net greenhouse gas footprint estimate, the greenhouse gas footprint equivalent being indicative of greenhouse gas emissions from a comparative source, wherein the processing portion for providing an indicia of at least one of the greenhouse gas emission estimate and the greenhouse gas reduction estimate is further configured to provide an indicia of the greenhouse gas footprint equivalent, so as to provide a comparison to the user via the display device.

19. A system according to claim 15 wherein the processing portion for determining from the facility parameters at least one of a greenhouse gas emission estimate and a greenhouse gas reduction estimate is configured to determine from the facility parameters at least one of the greenhouse gas emission estimate and the greenhouse gas reduction estimate based on greenhouse gas emissions or equivalents thereof.

20. A system according to claim 15 wherein the processing portion for receiving a query from a user is further configured to receive a query associated with a plurality of facility parameters defined over a predetermined duration of time.

21. A system according to claim 15 further comprising a processing portion for generating a report capable of being transmitted to the user, the report including a sustainable management strategy capable of being implemented to reduce the determined greenhouse gas emission estimate of the commercial facility.

22. A method for providing greenhouse gas footprint information associated with one of a commercial and municipal facility, the method being implemented over a computer network and comprising:
receiving a query from a user over the computer network, the query being associated with a plurality of facility parameters associated with one of a commercial and municipal facility;
determining, via a processor portion, from the facility parameters at least one of a greenhouse gas emission estimate indicative of an amount of emitted greenhouse gas associated with the facility and a greenhouse gas reduction estimate indicative of an amount of greenhouse gas sequestered by the facility; and
providing an indicia of at least one of the greenhouse gas emission estimate and the greenhouse gas reduction estimate via a display device in direct response to the query, so as to provide greenhouse gas footprint information capable of use in evaluating an environmental impact of the facility.

23. A method according to claim 22 wherein receiving a query from a user is further comprises receiving a query associated with a plurality of facility parameters associated with a facility profile, energy consumption, maintenance activity and combinations thereof.

24. A method according to claim 22 further comprising determining a net greenhouse gas footprint estimate from the difference between the greenhouse gas emission estimate and the greenhouse gas reduction estimate.

25. A method according to claim 24 further comprising determining a greenhouse gas footprint equivalent corresponding to the determined net greenhouse gas footprint estimate, the greenhouse gas footprint equivalent being indicative of greenhouse gas emissions from a comparative source, wherein providing an indicia of at least one of the greenhouse gas emission estimate and the greenhouse gas reduction estimate further comprises providing an indicia of the greenhouse gas footprint equivalent via the display device, so as to provide a comparison to the user via the display device.

26. A method according to claim 22 wherein determining from the facility parameters at least one of a greenhouse gas emission estimate and a greenhouse gas reduction estimate further comprises determining from the facility parameters at least one of a greenhouse gas emission estimate and a greenhouse gas reduction estimate based on greenhouse gas emissions or equivalents thereof.

27. A method according to claim 22 wherein receiving a query from a user further comprises receiving a query associated with a plurality of facility parameters defined over a predetermined duration of time.

28. A method according to claim 22 further comprising generating a report capable of being transmitted to the user, the report including a sustainable management strategy capable of being implemented to reduce the determined greenhouse gas emission estimate of the commercial facility.

29. A computer device adapted for interaction with a user and configured to provide greenhouse gas footprint information associated with a golf facility, the computer device comprising:
a processing portion for receiving a query from a user, the query being associated with a plurality of turf management and facility parameters associated with a golf facility;
a processing portion for determining from the turf management and facility parameters at least one of a greenhouse gas emission estimate indicative of an amount of emitted greenhouse gas associated with the golf facility and a greenhouse gas reduction estimate indicative of an amount of greenhouse gas sequestered by the golf facility; and
a processing portion for providing an indicia of the at least one of the greenhouse gas emission estimate and the greenhouse gas reduction estimate via a display device in direct response to the query, so as to provide carbon dioxide footprint information capable of use in evaluating an environmental impact of the golf facility.

30. A computer device according to claim 29 wherein the processing portion for receiving a query from a user is further configured to receive a query associated with a plurality of turf management and facility parameters associated with a golf facility profile, energy consumption, maintenance activity, a chemical treatment program and combinations thereof.

31. A computer device according to claim 29 further comprising a processing portion for determining a net greenhouse gas footprint estimate from the difference between the greenhouse gas emission estimate and the greenhouse gas reduction estimate.

32. A computer device according to claim 31 further comprising a processing portion for determining a greenhouse gas footprint equivalent corresponding to the determined net greenhouse gas footprint estimate, the greenhouse gas footprint equivalent being indicative of greenhouse gas emissions from a comparative source, wherein the processing portion for providing an indicia of at least one of the greenhouse gas emission estimate and the greenhouse gas reduction estimate is further configured to provide an indicia of the greenhouse gas footprint equivalent, so as to provide a comparison to the user via the display device.

33. A computer device according to claim 29 wherein the processing portion for determining from the turf management and facility parameters at least one of a greenhouse gas emission estimate and a greenhouse gas reduction estimate is configured to determine from the turf management and facility parameters at least one of a greenhouse gas emission estimate and a greenhouse gas reduction estimate based on greenhouse gas emissions or equivalents thereof.

34. A computer device according to claim 29 wherein the processing portion for receiving a query from a user is further configured to receive a query associated with a plurality of turf management and facility parameters defined over a predetermined duration of time.

35. A computer device according to claim 29 further comprising a processing portion for generating a report capable of being transmitted to the user, the report including a sustainable management strategy capable of being implemented to reduce the determined greenhouse gas emission estimate of the golf facility.

36. An intermediary computer device configured to implement a system for providing greenhouse gas footprint information associated with a golf facility, the intermediary computer device being configured to be in communication with a computer network so as to be capable of communicating with a discrete computer device adapted to be used by the user, said intermediary computer device comprising:
a processing portion for receiving a query from a user, the query being associated with a plurality of turf management and facility parameters associated with a golf facility;
a processing portion for determining from the turf management and facility parameters at least one of a greenhouse gas emission estimate indicative of an amount of emitted greenhouse gas associated with the golf facility and a greenhouse gas reduction estimate indicative of the amount of greenhouse gas sequestered by the golf facility; and
a processing portion for providing an indicia of at least one of the greenhouse gas emission estimate and the greenhouse gas reduction estimate via a display device in direct response to the query, so as to provide greenhouse gas footprint information capable of use in evaluating an environmental impact of the golf facility.

37. An intermediary computer device according to claim 36 wherein the processing portion for receiving a query from a user is further configured to receive a query associated with a plurality of turf management and facility parameters associated with a golf facility profile, energy consumption, maintenance activity, a chemical treatment program and combinations thereof.

38. An intermediary computer device according to claim 36 further comprising a processing portion for determining a net greenhouse gas footprint estimate from the difference between the greenhouse gas emission estimate and the greenhouse gas reduction estimate.

39. An intermediary computer device according to claim 38 further comprising a processing portion for determining a greenhouse gas footprint equivalent corresponding to the determined net greenhouse gas footprint estimate, the greenhouse gas equivalent being indicative of greenhouse gas emissions from a comparative source, wherein the processing portion for providing an indicia of at least one of the greenhouse gas emission estimate and the greenhouse gas reduction estimate is further configured to provide an indicia of the greenhouse gas footprint equivalent, so as to provide a comparison to the user via the display device.

40. An intermediary computer device according to claim 36 wherein the processing portion for determining from the turf management and facility parameters at least one of a greenhouse gas emission estimate and a greenhouse gas reduction estimate is configured to determine from the turf management and facility parameters at least one of a greenhouse gas emission estimate and a greenhouse gas reduction estimate based on greenhouse gas emissions or equivalents thereof.

41. An intermediary computer device according to claim 36 wherein the processing portion for receiving a query from a user is further configured to receive a query associated with a plurality of turf management and facility parameters defined over a predetermined duration of time.

42. An intermediary computer device according to claim 36 further comprising a processing portion for generating a report capable of being transmitted to the user, the report including a sustainable management strategy capable of being implemented to reduce the determined greenhouse gas emission estimate of the golf facility.

43. A system for providing greenhouse gas footprint information associated with a golf facility, said system comprising:
a first computer device configured to be in communication with a computer network, the first computer device comprising:
a processing portion for receiving a query from a user, the query being associated with a plurality of turf management and facility parameters associated with a golf facility;
a processing portion for determining from the turf management and facility parameters at least one of a greenhouse gas emission estimate indicative of an amount of emitted greenhouse gas associated with the golf facility and a greenhouse gas reduction estimate indicative of an amount of greenhouse gas sequestered by the golf facility; and
a processing portion for providing an indicia of at least one of the greenhouse gas emission estimate and the greenhouse gas reduction estimate via a display device in direct response to the query, so as to provide greenhouse gas footprint information capable of use in evaluating an environmental impact of the golf facility.

44. A system according to claim 43 wherein the processing portion for receiving a query from a user is further configured to receive a query associated with a plurality of turf management and facility parameters associated with a golf facility profile, energy consumption, maintenance activity, a chemical treatment program and combinations thereof.

45. A system according to claim 43 further comprising a processing portion for determining a net greenhouse gas footprint estimate from the difference between the greenhouse gas emission estimate and the greenhouse gas reduction estimate.

46. A system according to claim 45 further comprising a processing portion for determining a greenhouse gas footprint equivalent corresponding to the determined net greenhouse gas footprint estimate, the greenhouse gas footprint equivalent being indicative of greenhouse gas emissions from a comparative source, wherein the processing portion for providing an indicia of at least one of the greenhouse gas emission estimate and the greenhouse gas reduction estimate is further configured to provide an indicia of the greenhouse gas footprint equivalent, so as to provide a comparison to the user via the display device.

47. A system according to claim 43 wherein the processing portion for determining from the turf management and facility parameters at least one of a greenhouse gas emission estimate and a greenhouse gas reduction estimate is configured to determine from the turf management and facility parameters at least one of a greenhouse gas emission estimate and a greenhouse gas reduction estimate based on greenhouse gas emissions or equivalents thereof.

48. A system according to claim 43 wherein the processing portion for receiving a query from a user is further configured to receive a query associated with a plurality of turf management and facility parameters defined over a predetermined duration of time.

49. A system according to claim 43 further comprising a processing portion for generating a report capable of being transmitted to the user, the report including a sustainable management strategy capable of being implemented to reduce the determined greenhouse gas emission estimate of the golf facility.

50. A method for providing greenhouse gas footprint information associated with a golf facility, the method being implemented over a computer network and comprising:
receiving a query from a user over the computer network, the query being associated with a plurality of turf management and facility parameters associated with a golf facility;
determining, via a processor portion, from the turf management and facility parameters at least one of a greenhouse gas emission estimate indicative of an amount of emitted greenhouse gas associated with the turf management program and a greenhouse gas reduction estimate indicative of an amount of greenhouse gas sequestered by the golf facility; and
providing an indicia of at least one of the greenhouse gas emission estimate and the greenhouse gas reduction estimate via a display device in direct response to the query, so as to provide greenhouse gas footprint information capable of use in evaluating an environmental impact of the golf facility.

51. A method according to claim 50 wherein receiving a query from a user further comprises receiving a query associated with a plurality of turf management and facility parameters associated with a golf facility profile, energy consumption, maintenance activity, a chemical treatment program and combinations thereof.

52. A method according to claim 50 further comprising determining a net greenhouse gas footprint estimate from the difference between the greenhouse gas emission estimate and the greenhouse gas reduction estimate.

53. A method according to claim 52 further comprising determining a greenhouse gas footprint equivalent corresponding to the determined greenhouse gas footprint estimate, the greenhouse gas footprint equivalent being indicative of greenhouse gas emissions from a comparative source, wherein providing an indicia of at least one of the greenhouse gas emission estimate and the greenhouse gas reduction estimate further comprises providing an indicia of the greenhouse gas emission equivalent via the display device, so as to provide a comparison to the user via the display device.

54. A method according to claim 50 wherein determining from the turf management and facility parameters at least one of a greenhouse gas emission estimate and a greenhouse gas reduction estimate further comprises determining from the turf management and facility parameters at least one of a greenhouse gas emission estimate and a greenhouse gas reduction estimate based on greenhouse gas emissions or equivalents thereof.

55. A method according to claim 50 wherein receiving a query from a user further comprises receiving a query associated with a plurality of turf management and facility parameters defined over a predetermined duration of time.

56. A method according to claim 50 further comprising generating a report capable of being transmitted to the user, the report including a sustainable management strategy capable of being implemented to reduce the determined greenhouse gas emission estimate of the golf facility.
